(19) United States
(12) Patent Application Publication
(10) Pub. No.: US 2023/0394745 A1
(43) Pub. Date: Dec. 7, 2023

(54) INFORMATION PROCESSING APPARATUS, INFORMATION PROCESSING METHOD, AND INFORMATION PROCESSING SYSTEM

(71) Applicant: Sony Group Corporation, Tokyo (JP)

(72) Inventor: Sho OGURA, Kanagawa (JP)

(73) Assignee: Sony Group Corporation, Tokyo (JP)

(21) Appl. No.: 18/033,958

(22) PCT Filed: Nov. 10, 2021
(86) PCT No.: PCT/JP2021/041384

§ 371 Date: Apr. 26, 2023

(30) Foreign Application Priority Data
Nov. 20, 2020 (JP) 2020-193377

(51) Int. Cl. G06T 15/20

(52) U.S. Cl. CPC G06T 15/205; G06T 2210/52

(57) ABSTRACT

An information processing apparatus according to the present technology includes a determination unit that determines whether or not to generate a free viewpoint image by distributed processing using a plurality of processors on the basis of related information of processing related to the free viewpoint image.

### TECHNICAL FIELD

The present technology relates to an information processing apparatus, a method thereof, and an information processing system, and particularly relates to a technology of processing related to a free viewpoint image in which an imaged subject can be observed from an optional viewpoint in a three-dimensional space.

### BACKGROUND ART

There is known a technique for generating a free viewpoint image (also referred to as a free viewpoint video, a virtual viewpoint image (video), or the like) corresponding to an observation image from an optional viewpoint in the three-dimensional space on the basis of three-dimensional information representing an imaged subject in the three-dimensional space.

Patent Document 1 below can be cited as a related conventional technique. Patent Document 1 discloses a technique regarding generation of the camerawork that can be regarded as a movement trajectory of a viewpoint.

### CITATION LIST

### Patent Document

Patent Document 1: International Patent Application WO 2018/030206

### SUMMARY OF THE INVENTION

### Problems to be Solved by the Invention

The free viewpoint image is also useful as broadcast content, and is also used as, for example, a replay image of sports broadcasting. For example, in broadcast of soccer or basketball, a clip of several seconds such as a shooting scene is created from images recorded in real time, and broadcast as a replay image. Note that, in the present disclosure, the “clip” refers to an image of a certain scene created by cutting out from or further processing the recorded image.

Meanwhile, in a broadcasting site, particularly in the case of live broadcasting, an operator is required to quickly create a clip for replay and broadcast the clip. For example, there is a demand for broadcasting a replay 10 seconds after a play. Such a demand is similarly applied to creation of a clip including a free viewpoint image.

The present technology has been made in view of the above circumstances, and an object thereof is to be able to quickly create a clip including a free viewpoint image.

### Solutions to Problems

An information processing apparatus according to the present technology includes a determination unit that determines whether or not to generate a free viewpoint image by distributed processing using a plurality of processors on the basis of related information of processing related to the free viewpoint image.

Examples of the processing related to the free viewpoint image include input of information necessary for generating the free viewpoint image, image generation processing, processing of outputting the generated image, and the like. For example, on the basis of related information of these processing, it is determined whether or not to generate the free viewpoint image by distributed processing using the plurality of processors.

In the above-described information processing apparatus according to the present technology, the related information can take a configuration that includes information related to features of the free viewpoint image.

Therefore, it is possible to determine whether or not to execute distributed processing on the basis of, for example, the features of the free viewpoint image, such as a time length of the free viewpoint image and a generation processing load.

In the above-described information processing apparatus according to the present technology, the related information can take a configuration that includes information related to the time length of the free viewpoint image.

If the distributed processing is selected in a case where the time length of the free viewpoint image to be generated is short, there is a case where the time required for clip creation becomes longer. According to the above configuration, it becomes possible to determine whether or not to execute distributed processing on the basis of the time length of the free viewpoint image to be generated.

In the above-described information processing apparatus according to the present technology, the related information can take a configuration that includes information related to the generation processing load of the free viewpoint image.

The generation processing load of the free viewpoint image depends on, for example, the number of objects that are present in a target space and the like, and the processing time required for image generation also increases when the generation processing load is high. According to the above configuration, it becomes possible to determine whether or not to execute distributed processing on the basis of such a generation processing load.

In the above-described information processing apparatus according to the present technology, the related information can take a configuration that includes information related to the number of the free viewpoint images to be generated.

Depending on the number of the free viewpoint images to be generated, there is possibly a case where the time is shortened by the distributed processing or a case where the time is not shortened by the distributed processing.

In the above-described information processing apparatus according to the present technology, the related information can take a configuration that includes information related to the number of the processors.

Depending on the number of the processors, there is possibly a case where the time is shortened by the distributed processing or a case where the time is not shortened by the distributed processing.

In the above-described information processing apparatus according to the present technology, the related information can take a configuration that includes information related to processing capability of the processor.

For example, in a case where a processor having significantly low processing capability is included or the like, there is possibly a case where the time required for clip creation can be shortened without executing distributed processing depending on the processing capability of the processor.

In the above-described information processing apparatus according to the present technology, the related information can take a configuration that includes evaluation information related to communication between the processor and an external device.

Examples of evaluation information related to communication include, for example, information on communication line speed, a packet loss rate, information on radio wave strength in wireless communication, and the like. For a processor which is evaluated low in communication, even if the generation processing itself is fast with high processing capability, it takes time to input information necessary for generating the free viewpoint image and output the generated image, and if the distributed processing using such a processor is selected, there is a possibility that the time required for clip creation becomes longer.

In the above-described information processing apparatus according to the present technology, in a case where the number of the free viewpoint images to be generated is larger than the number of the processors, in a case where the number of the free viewpoint images to be generated cannot be divided by the number of the processors, the determination unit can take a configuration in which a determination result can be obtained, the result indicating that generation by the distributed processing is to be executed.

In a case where the number of the free viewpoint images is larger than the number of the processors and the number of the free viewpoint images cannot be divided by the number of the processors, the time required for clip creation can be shorten by generating the free viewpoint images by distributed processing using the plurality of processors rather than causing the plurality of processors to execute generation processing of different free viewpoint images in parallel.

In the above-described information processing apparatus according to the present technology, in a case where the number of free viewpoint images to be generated is not larger than the number of the processors, the determination unit can take a configuration in which a determination result can be obtained, the result indicating that a plurality of the processors executes generation processing of different free viewpoint images in parallel.

In a case where the number of free viewpoint images is not larger than the number of the processors, the time required for clip creation can be shortened by causing the plurality of processors to execute generation processing of different free viewpoint images in parallel rather than generating the free viewpoint images by distributed processing using the plurality of processors.

In the above-described information processing apparatus according to the present technology, the determination unit can take a configuration in which a method of the determination is switched on the basis of the magnitude relationship between the number of the free viewpoint images to be generated and the number of the processors.

With this arrangement, the method of determination can be switched in response to a case where the determination condition as to whether or not to select the distributed processing is different between a case where the number of the free viewpoint images is larger than the number of the processors and a case where the number of the free viewpoint images is not larger than the number of the processors.

An information processing method according to the present technology includes determining, by an information processing apparatus, whether or not to generate a free viewpoint image by distributed processing using a plurality of processors on the basis of related information of processing related to the free viewpoint image.

Also with such an information processing method, effects similar to those of the information processing apparatus described above according to the present technology can be obtained.

An information processing system according to the present technology includes: a storage device that stores a plurality of captured images having different viewpoints; a plurality of processors that can execute generation processing of a free viewpoint image based on the plurality of captured images stored in the storage device; and an information processing apparatus including a determination unit that determines whether or not to generate the free viewpoint image by distributed processing using a plurality of the processors on the basis of related information of processing related to the free viewpoint image.

Also with such an information processing system, effects similar to those of the information processing apparatus described above according to the present technology can be obtained.

### BRIEF DESCRIPTION OF DRAWINGS

FIG. 1 is a block diagram of a system configuration according to an embodiment of the present technology.

FIG. 2 is an explanatory diagram of an arrangement example of a camera configured to generate a free viewpoint image according to the embodiment.

FIG. 3 is a block diagram of a hardware configuration of an information processing apparatus according to the embodiment.

FIG. 4 is an explanatory diagram of functions of an image creation controller according to the embodiment.

FIG. 5 is an explanatory diagram of functions of a free viewpoint image PC according to the embodiment.

FIG. 6 is an explanatory diagram of a viewpoint in the free viewpoint image according to the embodiment.

FIG. 7 is an explanatory diagram of an outline of a camerawork designation screen according to the embodiment.

FIG. 8 is an explanatory diagram of an outline of a creation operation screen according to the embodiment.

FIG. 9 is an explanatory diagram of an output clip according to the embodiment.

FIG. 10 is an explanatory diagram of the output clip including a still image FV clip according to the embodiment.

FIG. 11 is an explanatory diagram of the output clip including a moving image FV clip according to the embodiment.

FIG. 12 is an explanatory diagram of an example of an image of the output clip according to the embodiment.

FIG. 13 is an explanatory diagram of a work procedure of clip creation according to the embodiment.

FIG. 14 is an explanatory diagram of a work procedure of camera movement detection according to the embodiment.

FIG. 15 is an explanatory diagram of an example of the output clip according to the embodiment.

FIG. 16 is an explanatory diagram of processing of generating/outputting an FV clip according to the embodiment.

FIG. 17 is an explanatory diagram of a pattern A and a pattern B in a case where the number N of FVs is 2 and the number M of PCs 2 according to the embodiment.

FIG. 18 is an explanatory diagram of the pattern A and the pattern B in a case where the number N of FVs is 4 and the number M of PCs is 2 according to the embodiment.

FIG. 19 is an explanatory diagram of the pattern A and the pattern B in a case where the number N of FVs is 2 and the number M of PCs is 4 according to the embodiment.

FIG. 20 is an explanatory diagram of the pattern A and the pattern B in a case where the number N of FVs is 3 and the number M of PCs is 2 according to the embodiment.

FIG. 21 is an explanatory diagram of the pattern A and the pattern B in a case where the number N of FVs is 3 and the number M of PCs is 4 according to the embodiment.

FIG. 22 is a flowchart showing an example of a specific processing procedure that should be executed to achieve a speeding up method as the embodiment.

### MODE FOR CARRYING OUT THE INVENTION

Hereinafter, an embodiment is described in the following order.
<1. System configuration>
<2. Configuration of image creation controller and free viewpoint image PC>
<3. Outline of GUI>
<4. Clip including free viewpoint image>
<5. Clip creation processing>
<6. Camera movement detection>
<7. Example of output clip and generation/output processing of FV clip>
<8. Method of speeding up clip creation>
<9. Processing procedure>
<10. Modified examples>
<11. Summary of embodiment>
<12. Present technology>

### 1. System Configuration

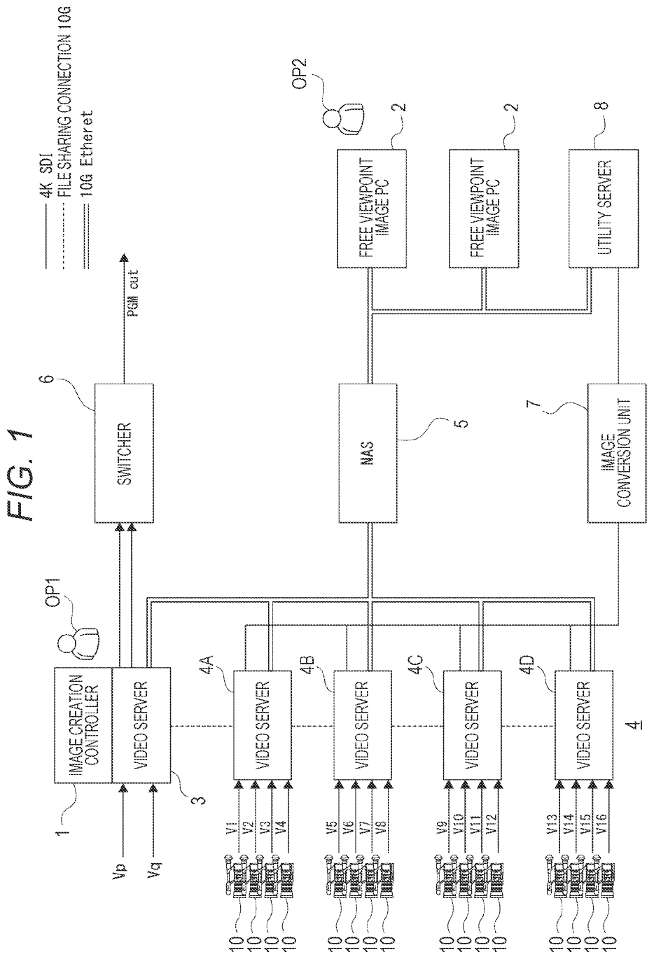

FIG. 1 is a diagram showing a configuration example of an image processing system according to an embodiment of the present technology.

The image processing system includes an image creation controller 1, a plurality of free viewpoint image personal computers (PCs) 2, a video server 3, a plurality of (for example, four) video servers 4A, 4B, 4C, and 4D, a network attached storage (NAS) 5, a switcher 6, an image conversion unit 7, a utility server 8, and a plurality of (for example, 16) imaging devices 10.

Note that, hereinafter, the term “camera” refers to the imaging device 10. For example, “camera arrangement” means arrangement of a plurality of the imaging devices 10.

In addition, when the video servers 4A, 4B, 4C, and 4D are collectively referred to without being particularly distinguished from each other, the video servers are referred to as “video servers 4”.

In this image processing system, a free viewpoint image corresponding to an observation image from an optional viewpoint in the three-dimensional space can be generated on the basis of captured images (for example, image data V1 to V16) acquired from the plurality of imaging devices 10, and an output clip including the free viewpoint image can be created.

In FIG. 1, a connection state of each of the units is indicated by a solid line, a broken line, and a double line.

A solid line indicates connection of a serial digital interface (SDI) which is an interface standard for connecting broadcast devices such as a camera and a switcher, and for example, supports 4K. The image data is mainly transmitted and received between each of the devices by SDI wiring.

The double line indicates connection of a communication standard for constructing a computer network, for example, 10 Gigabit Ethernet. The image creation controller 1, the free viewpoint image PC 2, the video servers 3, 4A, 4B, 4C, and 4D, the NAS 5, and the utility server 8 are connected by a computer network to allow image data and various types of control signals to be transmitted and received to and from each other.

A broken line between the video servers 3 and 4 indicates a state in which the video servers 3 and 4 equipped with the inter-server file sharing function are connected via, for example, a 10G network. With this arrangement, between the video server 3 and the video servers 4A, 4B, 4C, and 4D, each video server can preview materials in other video servers or send out materials to other video servers. That is, a system using a plurality of video servers is constructed, and efficient highlight editing and sending out can be realized.

Each imaging device 10 is configured as, for example, a digital camera device having an imaging element such as a charge coupled device (CCD) sensor and a complementary metal oxide semiconductor (CMOS) image sensor, and obtains captured images (image data V1 to V16) as digital data. In the present example, each imaging device 10 obtains a captured image as a moving image.

In the present example, each imaging device 10 captures an image of a scene in which a competition such as basketball or soccer is being held, and each imaging device is arranged in a predetermined direction at a predetermined position in a competition site where the competition is held. In the present example, the number of the imaging devices 10 is 16, but the number of the imaging devices 10 is only required to be at least two or more to enable generation of a free viewpoint image. By increasing the number of imaging devices 10 and imaging a target subject from more angles, the accuracy of three-dimensional restoration of the subject can be improved, and the image quality of the virtual viewpoint image can be improved.

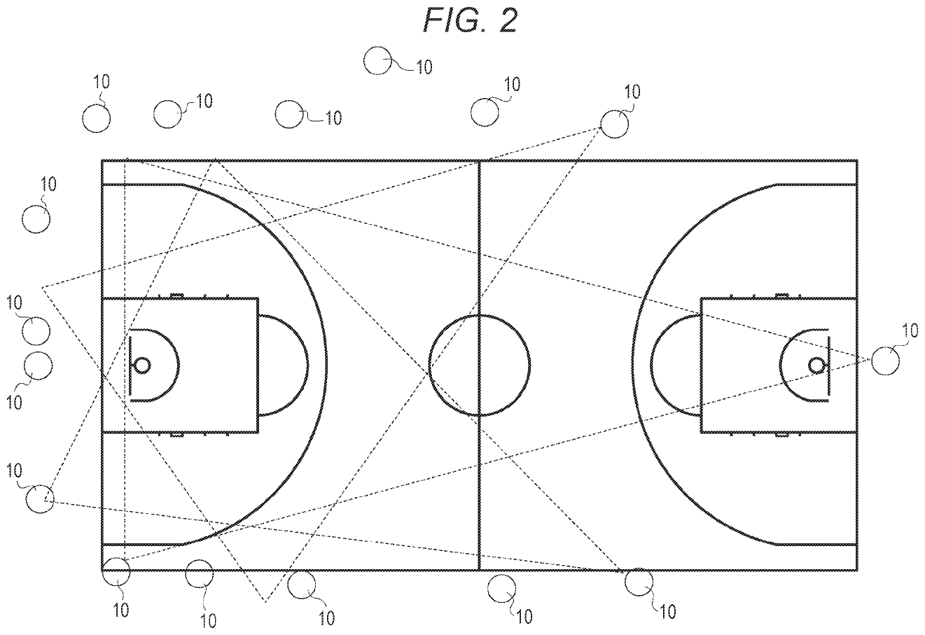

FIG. 2 shows an arrangement example of the imaging devices 10 around a basketball court. Circle marks represent the imaging devices 10. For example, this is a camera arrangement example in a case where the vicinity of the goal on the left side in the drawing is desired to be imaged. Needless to say, the arrangement and number of cameras are examples, and should be set according to the content and purpose of imaging and broadcasting.

The image creation controller 1 includes an information processing apparatus. This image creation controller 1 can be realized by using, for example, a dedicated workstation, a general-purpose personal computer, a mobile terminal device, or the like.

The image creation controller 1 performs control/operation management of the video servers 3 and 4 and processing for clip creation.

As an example, the image creation controller 1 is a device that can be operated by an operator OP1. The operator OP1 performs, for example, an instruction or the like to select or create clip contents.

The free viewpoint image PC 2 is configured as an information processing apparatus that actually executes processing of generating a free viewpoint image (free view (FV) clip described later) in accordance with the instruction or the like from the image creation controller 1. Here, an example in which the information processing apparatus that executes the free viewpoint image generation processing is constituted of a PC is described, but the information processing apparatus can also be realized by using, for example, a dedicated workstation, a mobile terminal device, or the like.

In this example, the free viewpoint image PC 2 is a device that can be operated by an operator OP2. The operator OP2 performs, for example, work related to generation of an FV clip as a free viewpoint image. Specifically, the operator OP2 performs a designation operation (selection operation) of the camerawork for generating the free viewpoint image. In addition, in the present example, the operator OP² also performs work of creating a camerawork described later.

FIG. 1 exemplifies a case where the number of the free viewpoint images PCs 2 is “two”, but this is merely an example, and the number of the free viewpoint image PCs 2 may be “three” or more.

Configurations and processing of the image creation controller 1 and the free viewpoint image PC 2 are described later in detail. Furthermore, it is assumed that the operators OP1 and OP2 perform operation, but for example, the image creation controller 1 and the free viewpoint image PC 2 may be arranged side by side and operated by one operator.

Each of the video servers 3 and 4 is an image recording device, and includes, for example, a data recording unit such as a solid state drive (SSD) or a hard disk drive (HDD), and a control unit that performs data recording/reproducing control for the data recording unit.

Each of the video servers 4A, 4B, 4C, and 4D can input, for example, four lines, and simultaneously records captured images of the four imaging devices 10.

For example, the video server 4A records the image data V1, V2, V3, and V4. The video server 4B records the image data V5, V6, V7, and V8. The video server 4C records the image data V9, V10, V11, and V12. The video server 4D records the image data V13, V14, V15, and V16.

With this arrangement, all the captured images of the 16 imaging devices 10 are simultaneously recorded.

The video servers 4A, 4B, 4C, and 4D perform constant recording, for example, during a sports game to be broadcast.

The video server 3 is, for example, directly connected to the image creation controller 1, and can perform, for example, input of two lines and output of two lines. Pieces of image data Vp and Vq are shown as inputs of two lines. As the pieces of image data Vp and Vq, captured images of any two imaging devices 10 (any two of the pieces of image data V1 to V16) can be selected. Needless to say, the captured image may be a captured image of another imaging device.

The image creation controller 1 can display the image data Vp and Vq on the display as monitor images. The operator OP1 can confirm the situation of the scene captured and recorded for broadcasting, for example, by the image data Vp and Vq input to the video server 3.

In addition, because the video servers 3 and 4 are connected in the file sharing state, the image creation controller 1 can monitor and display the captured image of each of the imaging devices 10 recorded in the video servers 4A, 4B, 4C, and 4D, and the operator OP1 can sequentially check the captured images.

Note that, in the present example, a time code is attached to a captured image captured by each imaging device 10, and frames can be synchronized in processing in the video servers 3, 4A, 4B, 4C, and 4D.

The NAS 5 is a storage device arranged on a network, and includes, for example, a storage unit such as an SSD or an HDD. In the case of the present example, when a part of the frames in the image data V1, V2, . . . , and V16 recorded in the video servers 4A, 4B, 4C, and 4D is transferred to the NAS 5 for free viewpoint image generation, the NAS 5 is a device that stores the transferred frames for processing in the free viewpoint image PC 2 or stores the created free viewpoint image.

The switcher 6 is a device that inputs images output via the video server 3 and selects a main line image PGMout to be finally selected and broadcast. For example, a broadcast director or the like performs necessary operation.

The image conversion unit 7 performs, for example, resolution conversion and composition of image data by the imaging device 10, generates a monitoring image of the camera arrangement, and supplies the monitoring image to the utility server 8. For example, 16 lines of image data (V1 to V16) to be 8K images are converted into four lines of images arranged in a tile shape after resolution conversion into 4K images, and the four lines of images are supplied to the utility server 8.

The utility server 8 is a computer device that can execute various types of related processing, and in a case of the present example, the utility server 8 is a device that executes processing of detecting camera movement for calibration. For example, the utility server 8 monitors image data from the image conversion unit 7 to detect the camera movement. The camera movement is, for example, movement of any arrangement position of the imaging devices 10 arranged as shown in FIG. 2. The information of the arrangement position of the imaging devices 10 is an important element for generating the free viewpoint image, and it is necessary to redo the parameter setting when the arrangement position changes. Therefore, camera movement is monitored.

### 2. Configuration of Image Creation Controller and Free Viewpoint Image PC

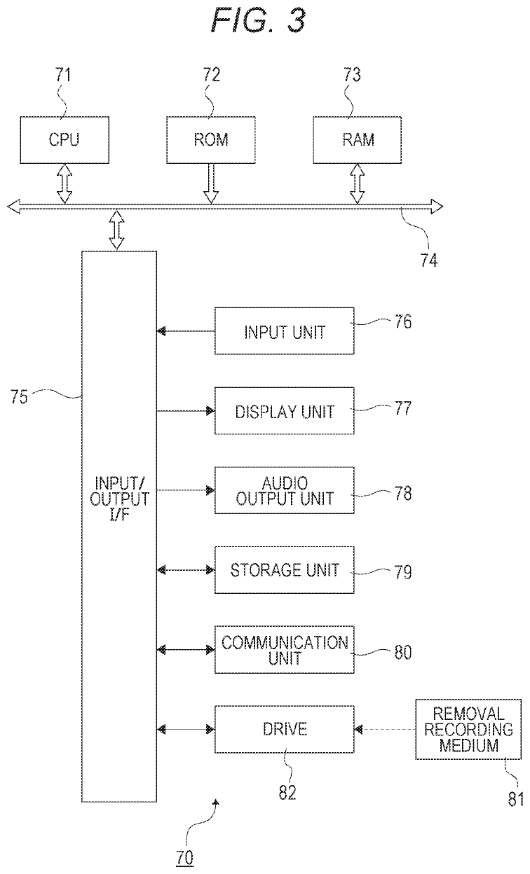

The image creation controller 1, the free viewpoint image PC 2, the video servers 3 and 4, and the utility server 8 having the above configuration can be realized as the information processing apparatus 70 having the configuration shown, for example, in FIG. 3.

In FIG. 3, a central processing unit (CPU) 71 of the information processing apparatus 70 executes various types of processing according to a program stored in a read only memory (ROM) 72 or a program loaded from a storage unit 79 to a random access memory (RAM) 73. In addition, the RAM 73 also appropriately stores data and the like necessary for the CPU 71 to execute the various types of processing.

The CPU 71, the ROM 72, and the RAM 73 are connected to one another via a bus 74. Furthermore, an input/output interface 75 is also connected to the bus 74.

An input unit 76 including an operation element and an operation device is connected to the input/output interface 75.

For example, as the input unit 76, various types of operation elements and operation devices such as a keyboard, a mouse, a key, a dial, a touch panel, a touch pad, a remote controller, and the like are assumed.

The operation by the user is detected by the input unit 76, and a signal corresponding to the input operation is interpreted by the CPU 71.

Furthermore, a display unit 77 including a liquid crystal display (LCD), an organic electro-luminescence (EL) panel, or the like, and an audio output unit 78 including a speaker or the like are integrally or separately connected to the input/output interface 75.

A display unit 77 is a display unit that performs various types of displays, and includes, for example, a display device provided in a housing of the information processing apparatus 70, a separate display device connected to the information processing apparatus 70, or the like.

The display unit 77 executes display of an image for various types of image processing, a moving image to be processed, and the like on a display screen on the basis of an instruction from the CPU 71. In addition, the display unit 77 displays various types of operation menus, icons, messages, and the like, that is, displays as a graphical user interface (GUI) on the basis of the instruction from the CPU 71.

In some cases, the storage unit 79 including a hard disk, a solid-state memory, or the like, and a communication unit 80 including a modem or the like are connected to the input/output interface 75.

The communication unit 80 performs communication processing via a transmission path such as the Internet, wired/wireless communication with various types of devices, bus communication, and the like.

In addition, a drive 82 is also connected to the input/output interface 75 as necessary, and a removable recording medium 81 such as a magnetic disk, an optical disk, a magneto-optical disk, a semiconductor memory, or the like is appropriately mounted.

The drive 82 can read a data file such as an image file MF, various types of computer programs, and the like from the removable recording medium 81. The read data file is stored in the storage unit 79, and images and sound included in the data file are output by the display unit 77 and the audio output unit 78. In addition, the computer program and the like read from the removable recording medium 81 are installed in the storage unit 79, as necessary.

In the information processing apparatus 70, software can be installed via network communication by the communication unit 80 or the removable recording medium 81. Alternatively, the software may be stored in advance in the ROM 72, the storage unit 79, or the like.

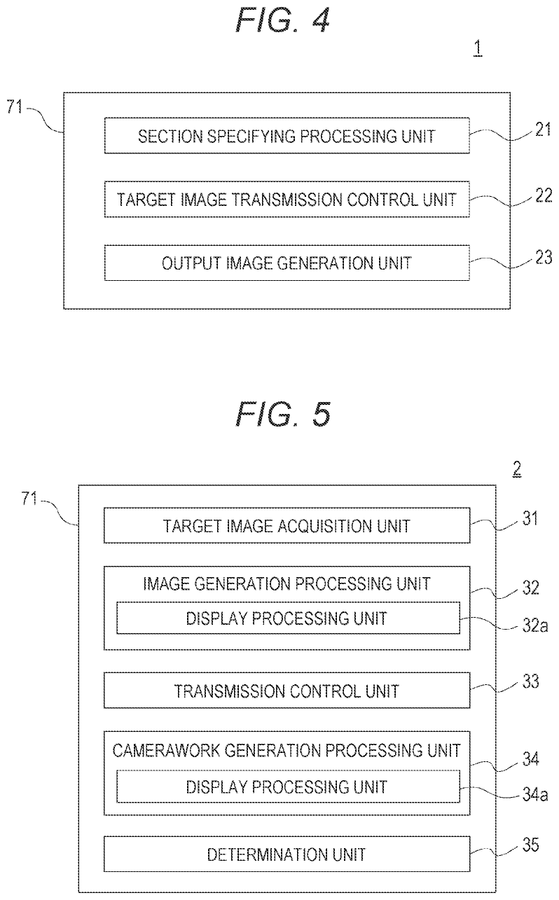

In a case where the image creation controller 1 and the free viewpoint image PC 2 are realized using such an information processing apparatus 70, the processing functions as shown in FIGS. 4 and 5 are realized in the CPU 71 by, for example, software.

FIG. 4 shows a section specifying processing unit 21, a target image transmission control unit 22, and an output image generation unit 23 as functions formed in the CPU 71 of the information processing apparatus 70 serving as the image creation controller 1.

The section specifying processing unit 21 executes processing of specifying a generation target image section as a generation target of the free viewpoint image for a plurality of captured images (image data V1 to V16) simultaneously captured by the plurality of imaging devices 10. For example, in response to the operator OP1 performing operation of selecting a scene to be replayed in the image, processing of specifying a time code for the scene, particularly a section (generation target image section) of the scene to be the free viewpoint image, and notifying the free viewpoint image PC 2 of the time code is performed.

Here, the generation target image section refers to a frame section that actually becomes the free viewpoint image. In a case where the free viewpoint image is generated for one frame in the moving image, the one frame is the generation target image section. In this case, an in-point and an out-point for the free viewpoint image have the same time code.

Furthermore, in a case where the free viewpoint image is generated for a plurality of frame sections in the moving image, the plurality of frames is the generation target image section. In this case, the in-point and the out-point for the free viewpoint image have the different time codes.

Note that, although the structure of the clip is described later, it is assumed that the in-point and the out-point of the generation target image section are different from the in-point and the out-point as the output clip to be finally generated. This is because a previous clip and a subsequent clip, which are described later, are coupled to the clip.

The target image transmission control unit 22 performs control to transmit the image data of the generation target image section in each of the plurality of imaging devices 10, that is, one or the plurality of frames of the image data V1 to V16, as the image data used for generating the free viewpoint image in the free viewpoint image PC 2. Specifically, control is performed to transfer the image data as the generation target image section from the video servers 4A, 4B, 4C, and 4D to the NAS 5.

The output image generation unit 23 executes processing of generating an output image (output clip) including the free viewpoint image (FV clip) generated and received by the free viewpoint image PC 2.

For example, by the processing of the output image generation unit 23, the image creation controller 1 combines the previous clip being the actual moving image at a previous time point, and a subsequent clip being the actual moving image at a subsequent time point, with the FV clip being the virtual image generated by the free viewpoint image PC 2, on a time axis to obtain the output clip. That is, the previous clip, the FV clip, and the subsequent clip are set as one output clip.

Needless to say, the previous clip and the FV clip may be set as one output clip.

Alternatively, the FV clip and the subsequent clip may be set as one output clip.

Further, an output clip that only includes the FV clip may be generated without having the previous clip and the subsequent clip combined.

In any case, the image creation controller 1 generates the output clip including the FV clip, outputs the output clip to the switcher 6, and allows the output clip to be used for broadcasting.

FIG. 5 shows a target image acquisition unit 31, an image generation processing unit 32, a transmission control unit 33, a camerawork generation processing unit 34, and a determination unit 35 as functions formed in the CPU 71 of the information processing apparatus 70 to be the free viewpoint image PC 2.

The target image acquisition unit 31 executes processing of acquiring an image data in the generation target image section as a generation target of the free viewpoint image for a plurality of captured images (image data V1 to V16) simultaneously captured by the plurality of imaging devices 10. That is, the image creation controller 1 is allowed to acquire image data of one frame or the plurality of frames specified by the in-point and the out-point of the generation target image section specified by the function of the section specifying processing unit 21 from the video servers 4A, 4B, 4C, and 4D via the NAS 5 and to use the image data in generating the free viewpoint image.

For example, the target image acquisition unit 31 acquires image data of one frame or the plurality of frames of the generation target image section for all the image data V1 to V16. The reason that the image data of the generation target image section is acquired for all the image data V1 to V16 is to generate a high-quality free viewpoint image. As described above, the free viewpoint image can be generated by using captured images of at least two or more imaging devices 10. However, by increasing the number of imaging devices 10 (that is, the number of viewpoints), a finer 3-dimensional (3D) model can be generated and a high-quality free viewpoint image can be generated. Therefore, for example, in a case where 16 imaging devices 10 are arranged, the image data of the generation target image section is acquired for all the image data (V1 to V16) of the 16 imaging devices 10.

The image generation processing unit 32 has a function of generating the free viewpoint image, that is, the FV clip in the case of the present example, using the image data acquired by the target image acquisition unit 31.

For example, the image generation processing unit 32 executes modeling processing including 3D model generation and subject analysis, and processing such as rendering for generating a free viewpoint image being a two-dimensional image from the 3D model.

The 3D model generation is processing of generating 3D model data representing a subject in the three-dimensional space (that is, the three-dimensional structure of the subject is restored from the two-dimensional image) on the basis of the captured image by each imaging device 10 and the camera parameter for every imaging device 10 input from, for example, the utility server 8 or the like. Specifically, the 3D model data includes data representing the subject in a three-dimensional coordinate system represented by (X,Y,Z).

In the subject analysis, a position, an orientation, and a posture of the subject as a person (player) are analyzed on the basis of the 3D model data. Specifically, in the subject analysis, the position of the subject is estimated, a simple model of the subject is generated, the orientation of the subject is estimated, and the like.

Then, the free viewpoint image is generated on the basis of the 3D model data and subject analysis information. For example, the free viewpoint image is generated such that the viewpoint is moved with respect to the 3D model in which the player being the subject is stationary.

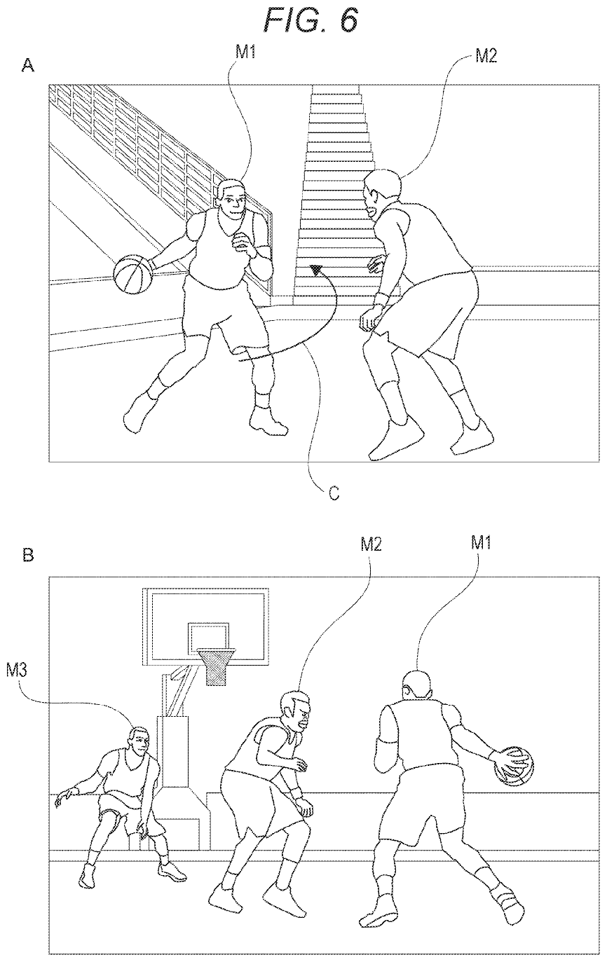

The viewpoint of the free viewpoint image is described with reference to FIG. 6.

FIG. 6A shows representation of the free viewpoint image capturing a subject from a certain viewpoint set in the three-dimensional space. In the free viewpoint image in this case, a subject M1 is viewed substantially from the front, and a subject M2 is viewed substantially from the back.

FIG. 6B shows representation of a virtual viewpoint image in a case where the position of the viewpoint is changed in the direction of an arrow C in FIG. 6A and the viewpoint for viewing the subject M1 substantially from the back is set. In the free viewpoint image in FIG. 6B, the subject M2 is viewed substantially from the front, and a subject M3 and a basket goal, which are not shown in FIG. 6A, are shown.

For example, the viewpoint is gradually moved in the direction of the arrow C from the state in FIG. 6A, and an image of about one second to several seconds leading to the state in FIG. 6B is generated as the free viewpoint image (FV clip). Needless to say, the time length of the FV clip as the free viewpoint image and a trajectory of the viewpoint movement can be variously considered.

Here, the free viewpoint image PC 2 (CPU 71) of the present example has a function as a display processing unit 32a as a part of the image generation processing unit 32.

The display processing unit 32a executes display processing of a camerawork designation screen Gs that receives designation operation of the camerawork information used for generating the free viewpoint image. Note that examples of the camerawork related to the free viewpoint image and the camerawork designation screen Gs are described again later.

The transmission control unit 33 performs control to transmit the free viewpoint image (FV clip) generated by the image generation processing unit 32 to the image creation controller 1 via the NAS 5. In this case, the transmission control unit 33 also controls to transmit accompanying information for output image generation to the image creation controller 1. The accompanying information is assumed to be information designating images of the previous clip and the subsequent clip. That is, the accompanying information is information designating which image of the image data V1 to V16 is used to create (cut out) the previous clip and the subsequent clip. The accompanying information is also assumed to be information designating the time lengths of the previous clip and the subsequent clip.

The camerawork generation processing unit 34 executes processing related to generation of camerawork information used for generating the free viewpoint image. In creating the free viewpoint image, a plurality of candidate camerawork is created in advance to adapt to various scenes. In order to enable such creation in advance of the camerawork, a software program for camerawork creation is installed in the free viewpoint image PC 2 of the present example. The camerawork generation processing unit 34 has a function realized by this software program, and executes camerawork generation processing on the basis of operation input by the user.

The camerawork generation processing unit 34 has a function as a display processing unit 34a. The display processing unit 34a executes display processing of a creation operation screen Gg to be described later in order to enable reception of various types of operation input for the camerawork creation by the user (the operator OP2 in the present example).

Here, although the plurality of free viewpoint image PCs 2 is provided in the image processing system of the present example, in this case, only one free viewpoint image PC 2 as a master includes the display processing unit 32a in the image generation processing unit 32 and the camerawork generation processing unit 34 described above. That is, in the image processing system of the present example, only one free viewpoint image PC 2 as a master is used as the free viewpoint image PC 2 that receives the designation of the camerawork information used to generate the free viewpoint image and the operation for creating the camerawork information.

The determination unit 35 executes, on the basis of related information of processing related to the free viewpoint image, whether or not to generate the free viewpoint image by distributed processing using the plurality of processors. Specifically, it is determined whether or not to generate the free viewpoint image by distributed processing using the plurality of free viewpoint image PCs 2. Note that the function of the determination unit 35 is described again later.

Here, in the present example, the function of the determination unit 35 is also a function of one free viewpoint image PC 2 as a master among the plurality of free viewpoint image PCs 2.

### 3. Outline of GUI

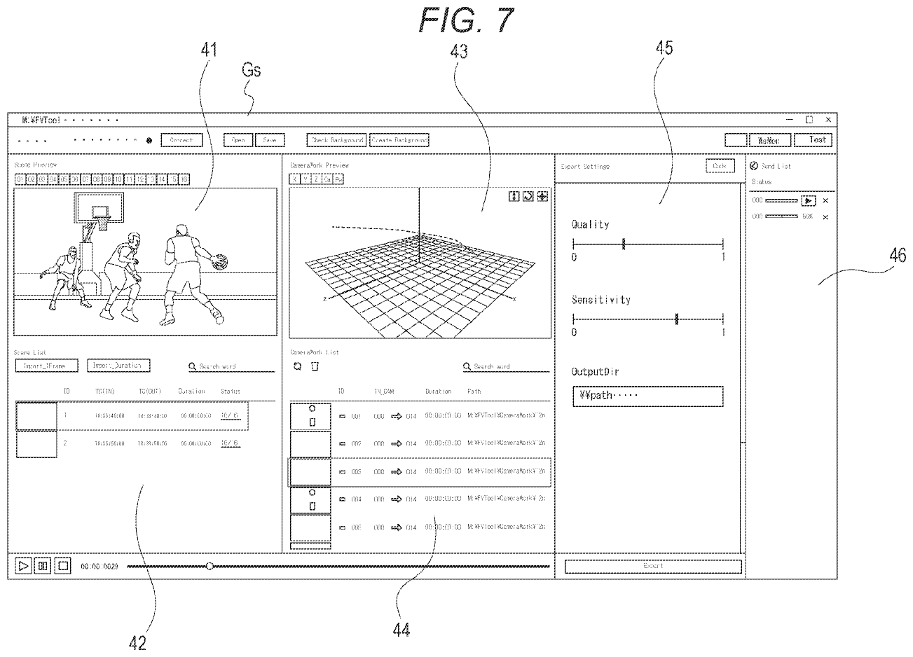

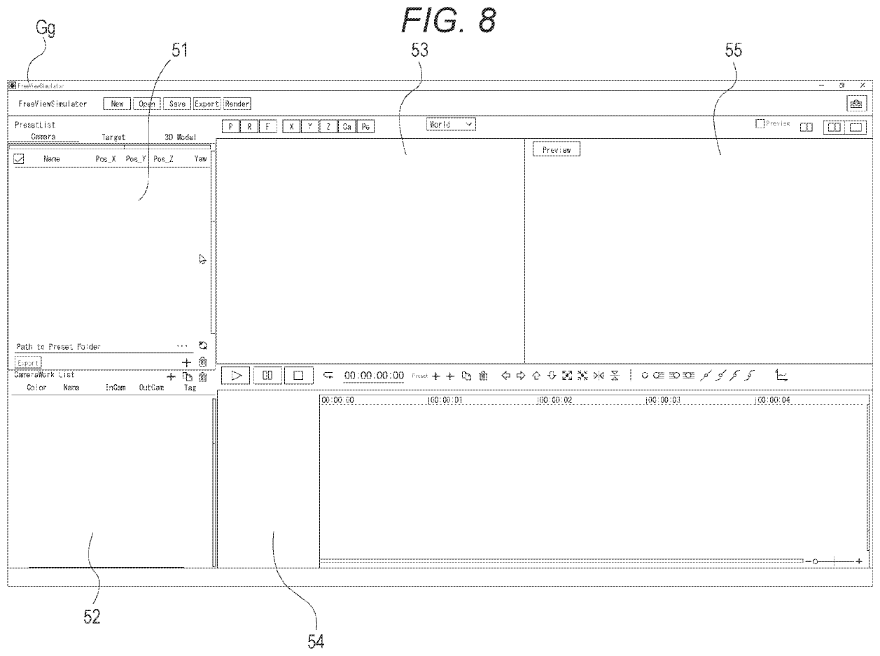

With reference to FIGS. 7 and 8, an outline of the camerawork designation screen Gs used for creating the free viewpoint image and the creation operation screen Gg used for creating the camerawork are described. In the present example, the camerawork designation screen Gs and the creation operation screen Gg are displayed, for example, on the display unit 77 in the free viewpoint image PC 2, and can be confirmed and operated by the operator OP².

In the camerawork designation screen Gs shown in FIG. 7, a scene window 41, a scene list display part 42, a camerawork window 43, a camerawork list display part 44, a parameter display part 45, and a transmission window 46 are arranged.

In the scene window 41, for example, the image of the generation target image section is monitor-displayed, and the operator OP2 can confirm the content of the scene from which the free viewpoint image is generated.

For example, a list of scenes designated as the generation target image section is displayed on the scene list display part 42. The operator OP2 can select a scene to be displayed in the scene window 41 in the scene list display part 42.

In the camerawork window 43, the position of the arranged imaging devices 10, the selected camerawork, a plurality of selectable camerawork, or the like is displayed.

Here, the camerawork information is information indicating at least a movement trajectory of the viewpoint in the free viewpoint image. For example, in a case of creating the FV clip in which the position of the viewpoint, the line-of-sight direction, and the angle of view (focal length) are changed with respect to the subject for which the 3D model has been generated, the camerawork information is parameters necessary for defining the movement trajectory of the viewpoint, the changing manner of the line-of-sight direction, and the changing manner of the angle of view.

In the camerawork window 43, at least information visualizing and indicating the movement trajectory of the viewpoint is displayed as the display of the camerawork.

The camerawork list display part 44 displays a list of information of various types of camerawork created and stored in advance. The operator OP2 can select and designate the camerawork to be used for FV clip generation from among the camerawork displayed on the camerawork list display part 44.

Various types of parameters related to the selected camerawork are displayed on the parameter display part 45.

In the transmission window 46, information regarding transmission of the created FV clip to the image creation controller 1 is displayed.

Next, the creation operation screen Gg of FIG. 8 is described.

On the creation operation screen Gg, a preset list display part 51, a camerawork list display part 52, a camerawork window 53, an operation panel part 54, and a preview window 55 are arranged.

The preset list display part 51 can selectively display a preset list of cameras, a preset list of targets, and a preset list of 3D models.

The preset list of cameras is list information of position information (position information in the three-dimensional space) of every camera preset by the user for the camera arrangement position at the site. As described later, in a case where the preset list of cameras is selected, information indicating the position for every piece of identification information (for example, camera 1, camera 2, . . . , camera 16) of the camera is displayed in a list form on the preset list display part 51.

Furthermore, in the preset list of targets, the target means a target position that determines the line-of-sight direction from the viewpoint in the free viewpoint image. In the generation of the free viewpoint image, the line-of-sight direction from the viewpoint is determined to face the target.

In a case where the preset list of targets is selected, the preset list display part 51 displays a list of identification information on targets preset by the user and information indicating the positions of the targets.

Here, the target that determines the line-of-sight direction from the viewpoint in the free viewpoint image as described above is referred to as a “target Tg”.

The preset list of 3D models is a preset list of 3D models to be displayed as a background of the camerawork window 43, and in a case where the preset list of 3D models is selected, the preset list display part 51 displays a list of identification information of the preset 3D models.

The camerawork list display part 52 can display a list of information of the camerawork created through the creation operation screen Gg and information (entry to be described later) of the camerawork to be newly created through the creation operation screen Gg.

In the camerawork window 53, at least information visualizing and indicating the movement trajectory of the viewpoint is displayed as the display of the camerawork.

The operation panel part 54 is a region that receives various types of operation inputs in the camerawork creation.

In the preview window 55, the observation image from the viewpoint is displayed. In a case where the operation of moving the viewpoint on the movement trajectory is performed, the observation images from respective viewpoint positions on the movement trajectory are sequentially displayed in the preview window 55. In addition, in a case where the operation of designating a camera from the preset list of cameras is performed in a state where the preset list of cameras is displayed on the preset list display part 51, the observation image viewed from the arrangement position of the camera is displayed in the preview window 55 of the present example.

For example, the user such as the operator OP2 can use such a creation operation screen Gg to create and edit the camerawork while sequentially previewing the content of the camerawork (image content change accompanying viewpoint movement).

### 4. Clip Including Free Viewpoint Image

Next, the output clip including the FV clip as the free viewpoint image is described.

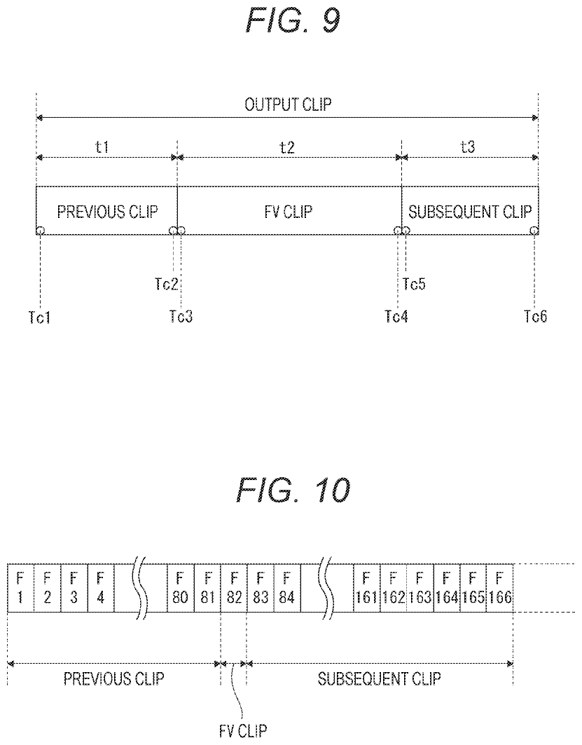

FIG. 9 shows a state of the output clip as an example configured by combining the previous clip, the FV clip, and the subsequent clip to each other.

For example, the previous clip is an actual moving image in a section of time codes TC1 to TC2 in certain image data Vx among the image data V1 to the image data V16.

Furthermore, the subsequent clip is an actual moving image in a section of time codes TC5 to TC6 in certain image data Vy among the image data V1 to the image data V16.

It is normally assumed that the image data Vx is the image data of the imaging device 10 before the start of the viewpoint movement in the FV clip, and the image data Vy is the image data of the imaging device 10 at the end of the viewpoint movement in the FV clip.

In this example, the previous clip is a moving image having a time length t1, the FV clip is a free viewpoint image having a time length t2, and the subsequent clip is a moving image having a time length t3. The reproduction time length of the entire output clip is t1+t2+t3. For example, the output clip for 5 seconds can have a configuration including a 1.5 second moving image, a 2 second free viewpoint image, and a 1.5 second moving image, or the like.

Here, the FV clip is shown as a section of time codes TC3 to TC4, but there is a case that this corresponds or does not correspond to the number of frames of the actual moving image.

That is, as the FV clip, there are cases where the viewpoint is moved in a state of the time of the moving image being stopped (where TC3=TC4) and where the viewpoint is moved without stopping the time of the moving image (where TC3 #TC4).

For description, the FV clip in a case where the viewpoint is moved in a state of the time of the moving image being stopped is referred to as a “still image FV clip”, and the FV clip in a case where the viewpoint is moved without stopping the time of the moving image is referred to as a “moving image FV clip”.

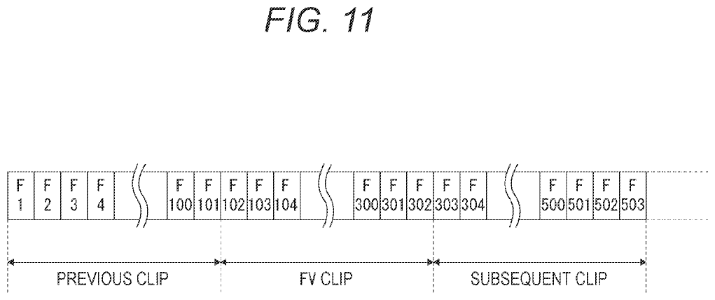

FIG. 10 shows the still image FV clip with reference to the frames of the moving image. In a case of this example, the time codes TC1 and TC2 of the previous clip are the time codes of the frames F1 and F81, respectively, and the time code of the following frame F82 is the time code TC3=TC4 in FIG. 9. Further, the time codes TC5 and TC6 of the subsequent clip are the time codes of the frames F83 and F166.

That is, this is the case of generating the free viewpoint image in which the viewpoint moves with respect to the still image including one frame which is the frame F82.

Meanwhile, the moving image FV clip is represented as shown in FIG. 11. In the case of this example, the time codes TC1 and TC2 of the previous clip are the time codes of the frames F1 and F101, respectively, and the time codes of the frames F102 and F302 are the time codes TC3 and TC4 in FIG. 9, respectively. Further, the time codes TC5 and TC6 of the subsequent clip are the time codes of the frames F303 and F503, respectively.

That is, this is the case of generating the free viewpoint image in which the viewpoint moves with respect to the moving image including a plurality of frames from the frame F102 to the frame 302.

Therefore, the generation target image section determined by the image creation controller 1 is a section of one frame which is the frame F82 in the case of creating the still image FV clip in FIG. 10, and is a section of the plurality of frames from the frame F102 to the frame 302 in the case of creating the moving image FV clip in FIG. 11.

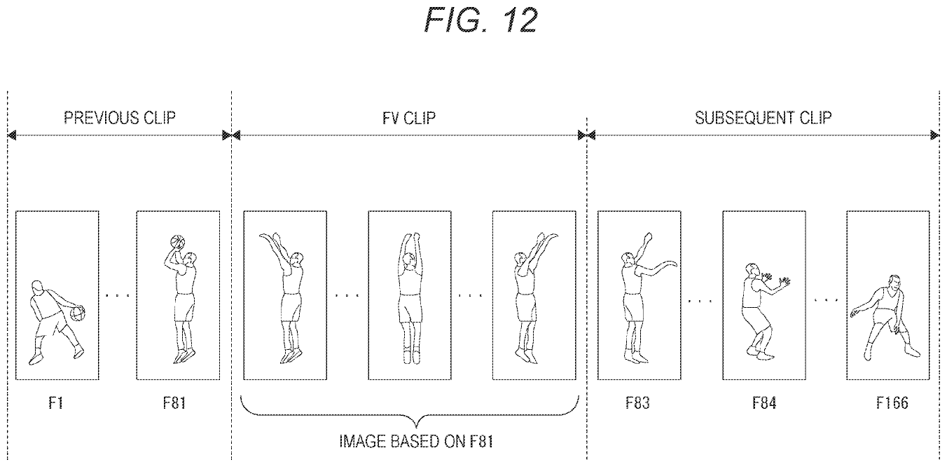

FIG. 12 shows an example of the image content of the output clip in the example of the still image FV clip in FIG. 10.

In FIG. 12, the previous clip is the actual moving image from the frame F1 to the frame F81. The FV clip is a virtual image in which the viewpoint is moved in the scene of the frame F81. The subsequent clip is the actual moving image from the frame F83 to the frame F166.

For example, the output clip including the FV clip is generated in this manner and used as an image to be broadcast.

### 5. Clip Creation Processing

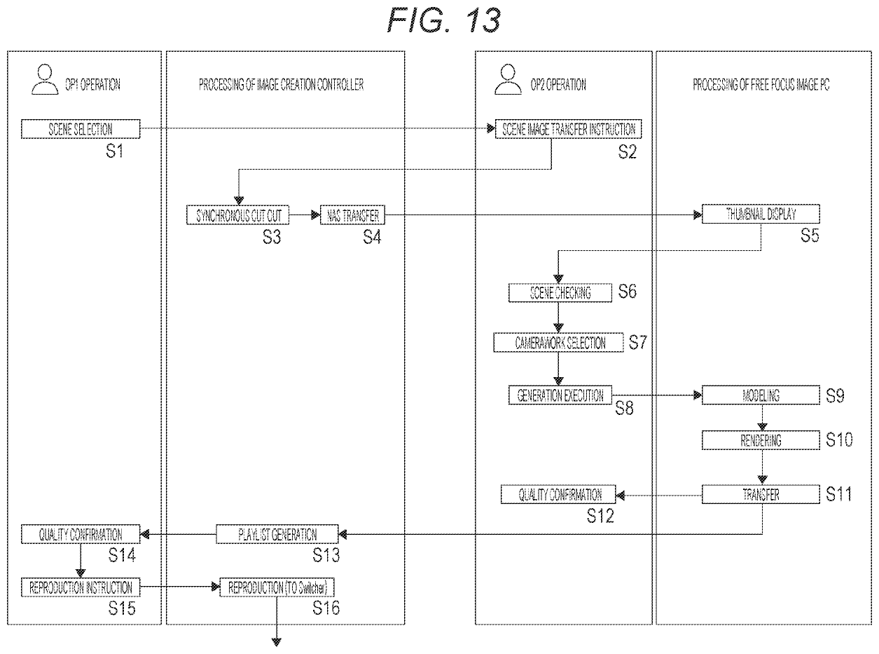

An example of processing of output clip creation executed in the image processing system in FIG. 1 is described with reference to FIG. 13. Here, processing of the image creation controller 1 and the free viewpoint image PC 2 are mainly focused in description. Note that, in FIG. 13, for the sake of explanation, it is assumed that there is only one free viewpoint image PC 2.

First, a flow of processing including operations of the operators OP1 and OP2 is described with reference to FIG. 13. Note that the processing of the operator OP1 in FIG. 13 collectively shows GUI processing and operator operation of the image creation controller 1. Furthermore, the processing of the operator OP2 collectively shows GUI processing and operator operation of the free viewpoint image PC 2.

Step S1: Scene Selection

At the time of creating the output clip, first, the operator OP1 selects a scene to be an FV clip. For example, the operator OP1 searches for a scene desired to be the FV clip while monitoring the captured images displayed on the display unit 77 on the image creation controller 1 side. Then, the generation target image section of one frame or a plurality of frames is selected.

The information of the generation target image section is transmitted to the free viewpoint image PC 2, and the operator OP2 can recognize the information by the GUI on the display unit 77 on the free viewpoint image PC 2 side.

Specifically, the information on the generation target image section is information on the time codes TC3 and TC4 in FIG. 9. As described above, in the case of the still image FV clip, the time code TC3=TC4.

Step S2: Scene Image Transfer Instruction

In response to the designation of the generation target image section, the operator OP2 performs operation of instructing to transfer the image of the corresponding scene. In response to this operation, the free viewpoint image PC 2 transmits a transfer request for image data in the sections of the time codes TC3 and TC4 to the image creation controller 1.

Step S3: Synchronous Cut Out

In response to the image data transfer request, the image creation controller 1 controls the video servers 4A, 4B, 4C, and 4D, and causes the video servers 4A, 4B, 4C, and 4D to cut out the sections of the time codes TC3 and TC4 for each of the 16 lines of image data from the image data V1 to the image data V16.

Step S4: NAS Transfer

Then, the image creation controller 1 transfers the data in all the sections of the time codes TC3 and TC4 of the image data V1 to the image data V16 to the NAS 5.

Step S5: Thumbnail Display

In the free viewpoint image PC 2, thumbnails of the image data V1 to the image data V16 in the sections of the time codes TC3 and TC4 transferred to the NAS 5 are displayed.

Step S6: Scene Checking

The operator OP2 checks the scene content of the sections indicated by the time codes TC3 and TC4 on the camerawork designation screen Gs using the free viewpoint image PC 2.

Step S7: Select Camerawork

The operator OP2 selects (designates) the camerawork considered to be appropriate on the camerawork designation screen Gs according to the scene content.

Step S8: Generation Execution

After selecting the camerawork, the operator OP2 performs operation to execute generation of the FV clip.

Step S9: Modeling

The free viewpoint image PC 2 performs generation of a 3D model of the subject, subject analysis, and the like by using data of frames in the sections of the time codes TC3 and TC4 in each piece of the image data V1 to V16, and parameters such as the arrangement position of each imaging device 10 input in advance.

Step S10: Rendering

The free viewpoint image PC 2 generates the free viewpoint image on the basis of the 3D model data and the subject analysis information. At this time, the free viewpoint image is generated to allow the viewpoint movement based on the camerawork selected in step S7 to be performed.

Step S11: Transfer

The free viewpoint image PC 2 transfers the generated FV clip to the image creation controller 1. At this time, not only the FV clip but also the designation information of the previous clip and the subsequent clip and the designation information of the time lengths of the previous clip and the subsequent clip can be transmitted as accompanying information.

Step S12: Quality Confirmation

Note that, on the free viewpoint image PC 2 side, the quality confirmation by the operator OP2 can be performed before or after the transfer in step S11. That is, the free viewpoint image PC 2 reproduces and displays the generated FV clip on the camerawork designation screen Gs so that the operator OP2 can confirm the FV clip. In some cases, the operator OP² is allowed to perform the generation of the FV clip again without executing the transfer.

Step S13: Playlist Generation

The image creation controller 1 generates the output clip by using the transmitted FV clip. In this case, one or both of the previous clip and the subsequent clip are combined to the FV clip on the time axis to generate the output clip.

The output clip may be generated as stream data in which each frame as the previous clip, each frame virtually generated as the FV clip, and each frame as the subsequent clip are actually combined in time series, but in this processing example, the frames are virtually combined as a playlist.

That is, the playlist is generated such that the frame section as the previous clip is reproduced, followed by reproduction of the FV clip, and thereafter, the frame section as the subsequent clip is reproduced, so that the output clip can be reproduced without having the stream data actually combined as the output clip generated.

Step S14: Quality Confirmation

The GUI on the image creation controller 1 side performs reproduction based on the playlist, and the operator OP1 checks the content of the output clip.

Step S15: Reproduction Instruction

The operator OP1 gives a reproduction instruction by predetermined operation according to the quality confirmation. The image creation controller 1 recognizes the input of the reproduction instruction.

Step S16: Reproduction

In response to the reproduction instruction, the image creation controller 1 supplies the output clip to the switcher 6. As a result, the broadcast of the output clip can be executed.

### 6. Camera Movement Detection

In order to generate the free viewpoint image, because the 3D model is generated using the image data V1, V2, . . . V16, parameters including position information of each imaging device 10 are important.

For example, in a case where the position of a certain imaging device 10 is moved or the imaging direction is changed in the pan direction, the tilt direction, or the like in the middle of broadcasting, the parameters are required to be calibrated corresponding thereto. Therefore, in the image processing system in FIG. 1, the utility server 8 detects the movement of the camera. Here, the movement of the camera means that at least one of the position or the imaging direction of the camera changes.

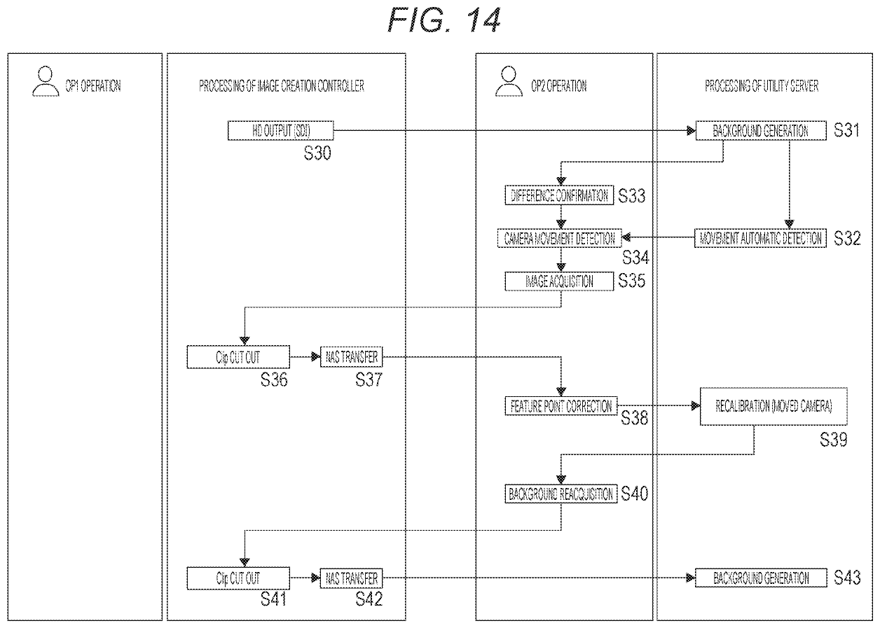

A processing procedure of the image creation controller 1 and the utility server 8 at the time of detecting the movement of the camera is described with reference to FIG. 14. Note that, FIG. 14 shows a processing procedure in a format similar to that in FIG. 13, but is an example where the operator OP2 also performs operation on the utility server 8.

Step S30: HD Output

The image creation controller 1 performs control to cause the image conversion unit 7 to output image data from the video servers 4A, 4B, 4C, and 4D for camera movement detection. Images from the video servers 4A, 4B, 4C, and 4D, that is, the images of the 16 imaging devices 10 are subjected to resolution conversion by the image conversion unit 7 and supplied to the utility server 8.

Step S31: Background Generation

The utility server 8 generates a background image on the basis of the supplied images. Because the background image is an image that does not change unless there is a movement in the camera, for example, a background image excluding the subject such as a player is generated for the pieces of image data of 16 lines (V1 to V16).

Step S32: Difference Confirmation

The background image is displayed as the GUI so that the operator OP2 can confirm the movement in the image.

Step S33: Movement Automatic Detection

The movement of the camera can also be automatically detected by executing comparison processing on the background image at each time point.

Step S34: Camera Movement Detection

As a result of step S33 or step S34 described above, the movement of a certain imaging device 10 is detected.

Step S35: Image Acquisition

Calibration is required in response to the detection of movement in the imaging device 10. Therefore, the utility server 8 requests the image creation controller 1 for the image data in the state after the movement.

Step 336: Clip Cut Out

The image creation controller 1 controls the video servers 4A, 4B, 4C, and 4D in response to the request for image acquisition from the utility server 8, and causes the video servers 4A, 4B, 4C, and 4D to execute clip cut out for the image data V1 to V16.

Step S37: NAS Transfer

The image creation controller 1 controls the video servers 4A, 4B, 4C, and 4D to transfer the image data cut out as a clip to the NAS 5.

Step S38: Feature Point Correction

By the transfer to the NAS 5, the utility server 8 can refer to and display the image in the state after the camera movement. The operator OP2 performs operation necessary for calibration such as feature point correction.

Step S39: Recalibration

The utility server 8 re-executes the calibration for creating the 3D model using the image data (V1 to V16) in the state after the camera movement.

Step S40: Background Reacquisition

After the calibration, in response to the operation of the operator OP2, the utility server 8 requests reacquisition of image data for the background image.

Step S41: Clip Cut Out

The image creation controller 1 controls the video servers 4A, 4B, 4C, and 4D in response to the request for image acquisition from the utility server 8, and causes the video servers 4A, 4B, 4C, and 4D to execute clip cut out for the image data V1 to V16.

Step S42: NAS Transfer

The image creation controller 1 controls the video servers 4A, 4B, 4C, and 4D to transfer the image data cut out as a clip to the NAS 5.

Step S43: Background Generation

The utility server 8 generates a background image on the basis of the image data transferred to the NAS 5. This is, for example, the background image serving as a reference for subsequent camera movement detection.

For example, by performing camera movement detection and calibration as in the above procedure, for example, even in a case where the position or the imaging direction of the imaging device 10 is changed during broadcasting, the parameters are corrected accordingly, so that an accurate FV clip can be continuously generated.

### 7. Example of Output Clip and Generation/Output Processing of FV Clip

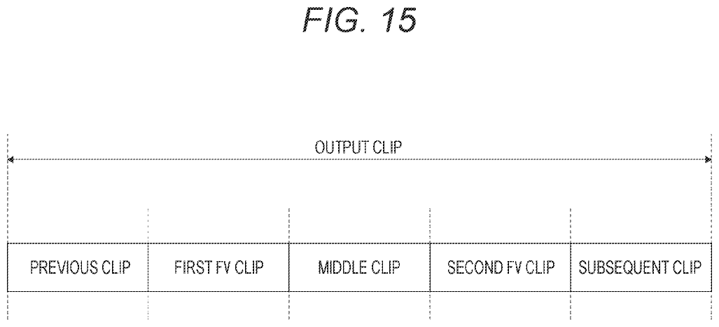

FIG. 15 is an explanatory diagram of an example of the output clip.

In FIG. 9 above, an example in which only one FV clip is included has been described as an example of the output clip, but the output clip may include two or more FV clips as shown in the drawing. Specifically, FIG. 15 shows the configuration of the output clip in which the free viewpoint image as the first FV clip is inserted between the moving images as the previous clip and the middle clip, and the free viewpoint image as the second FV clip is inserted between the moving images as the middle clip and the subsequent clip.

As an example of such an output clip, for example, a replay image of a golf swing is assumed, and it is conceivable that the two FV clips are the free viewpoint image at a top position (top-of-swing) and the free viewpoint image at an impact position, respectively. Specifically, in this case, the previous clip is a moving image of a take-back scene from an address state to the top position in the golf swing, the middle clip is a moving image of a scene from the top position to the impact position, and the subsequent clip is a moving image of a scene from the impact position to a finish position.

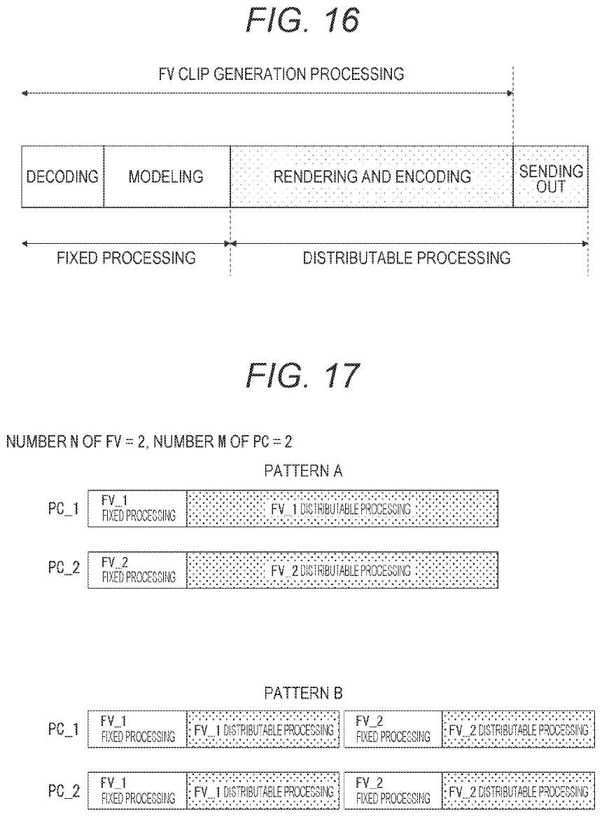

FIG. 16 is an explanatory diagram of processing of generating/outputting the FV clip.

As illustrated, the FV clip generation processing can be roughly divided into decoding, modeling, rendering, and encoding. The decoding is processing of decoding a plurality of pieces of image data used to generate the FV clip. The decoding as used herein means processing of converting target image data into a data format that can be handled in the FV clip generation processing. For example, in a case where all pieces of the image data V1 to the image data V16 are used to generate the FV clip, decoding processing is executed on these pieces of the image data V1 to V16.

The modeling is processing of generating the 3D model of a subject on the basis of the decoded image data. The 3D model generation of the subject is similar to that described for the image generation processing unit 32, and thus redundant description is avoided.

The rendering and encoding are processing of generating the free viewpoint image as the FV clip on the basis of the 3D model of the subject generated by the modeling processing and the information of the camerawork designated on the camerawork designation screen Gs described in FIG. 7. That is, the rendering and encoding is the processing of generating moving image data in which the viewpoint position changes according to the designated camerawork information, as the FV clip.

As described above, the free viewpoint image PC 2 transfers the generated FV clip to the image creation controller 1 via the NAS 5. “Sending out” processing in the drawing represents processing of sending out the FV clip generated in this manner to the NAS 5 at the time of transmitting the FV clip to the image creation controller 1.

### 8. Method of Speeding Up Clip Creation

Here, in the present example, the PC (processor) that can generate the free viewpoint image as the free viewpoint image PC 2 is provided in plural numbers. In this case, it is conceivable to speed up the creation of the output clip by generating the free viewpoint image by distributed processing using the plurality of PCs. In particular, in a case where the number of FV clips to be generated (hereinafter, also abbreviated as the “number of FVs”) is not only one but can be changed, it is important to share the generation processing in consideration of the relationship between the number of PCs and the number of FVs in order to improve the efficiency of output clip creation.

At this time, there are some cases that other factors are considered in addition to the number of PCs and the number of FVs to determine whether or not to execute the distributed processing. For example, in a case where there is a PC having significantly low processing capability, the time required to create the output clip is possibly shortened by not using the PC for generating the FV clip.

In addition, in a case where the time length of the FV clip is short, the time required to create the output clip is possibly shortened by a single PC taking charge of the FV clip as compared with a case where the FV clip is shared by a plurality of PCs.

Moreover, in a case where a scene with a large number of subjects such as players is targeted as the FV clip, the generation processing load of the FV clip increases, and the time required for generating the FV clip also increases. Conversely, in a case where the generation processing load is low, the time required to generate the FV clip is shortened, and in such a case, the time required for output clip creation is possibly shortened by not selecting the distributed processing.

Furthermore, in the present example, because the image creation controller 1 creates the output clip, the free viewpoint image PC 2 executes the processing of sending out the generated FV clip. However, in a case where the communication condition is bad and the sending out processing is delayed, the time required for creating the output clip is prolonged. For example, in a case where there is a PC whose communication condition is bad and sending out processing is taking time, the time required for output clip creation is possibly shortened by not using the PC for generating the FV clip.

Therefore, in the present embodiment, on the basis of related information of processing related to the free viewpoint image, it is determined whether or not to generate the free viewpoint image by distributed processing using the plurality of processors.

Examples of the processing related to the free viewpoint image include input of information necessary for generating the free viewpoint image, image generation processing, processing of outputting the generated image, and the like. For example, on the basis of related information of these processing, it is determined whether or not to generate the free viewpoint image by distributed processing using the plurality of processors.

Here, in the present example, the decoding and modeling processing shown in FIG. 16 are “fixed processing” in which distributed processing by a plurality of processors is disabled. On the other hand, the processing of rendering, encoding, and sending out is “distributable processing” in which distributed processing by a plurality of processors is possible.

In the following description, the “fixed processing” in the drawing is indicated by a white pattern, and the “distributable processing” is indicated by a dotted pattern.

In the present embodiment, it is determined whether or not the plurality of free viewpoint images PC 2 is subjected to the distributed processing with respect to the “distributable processing” for the FV clip to be processed.

Hereinafter, specific examples are described.

First, a “pattern A” and a “pattern B” are defined as examples of processing patterns.

The pattern A is a processing pattern in which, in a case where the number of the free viewpoint image PCs 2 and the number of FV clips to be generated are both plural, the plurality of free viewpoint image PCs 2 executes generation processing on different FV clips in parallel.

On the other hand, the pattern B is a processing pattern for generating a single FV clip by distributed processing using the plurality of free viewpoint image PCs 2 in a case where the number of the free viewpoint image PCs 2 is plural.

Hereinafter, the number of FV clips is referred to as “the number N of FVs”, and the number of the free viewpoint image PCs 2 is referred to as “the number M of PCs”. In the case of distinguishing the FV clips from each other, a numerical value is added following “FV_” as a reference numeral, and in the case of distinguishing the free viewpoint image PCs 2 from each other, a numerical value is similarly added following “PC_” as a reference numeral.

FIG. 17 is an explanatory diagram of the pattern A and the pattern B in a case where the number N of FVs is 2 and the number M of PCs is 2.

In this case, in the pattern A, only PC_1 is responsible for the fixed processing and the distributable processing of FV_1, and only PC_2 is responsible for the fixed processing and the distributable processing of FV_2. That is, the plurality of free viewpoint image PCs 2 as PC_1 and PC_2 executes the generation processing of different FV clips as FV_1 and FV_2 in parallel.

On the other hand, in the pattern B, the distributable processing of FV_1 is distributed by PC_1 and PC 2, and the distributable processing of FV_2 is also subjected to distributed processing by PC_1 and PC_2. In this example, because the fixed processing (decoding and modeling processing) cannot be distributed, the same processing is executed by PC_1 and PC_2 as the fixed processing of FV_1 and FV_2 in the drawing.

At this time, as a form of distribution of the distributable processing (rendering, encoding, and sending out in this example), for example, distribution by the number of frames can be exemplified. That is, in a case where the number of frames of the moving image as the FV clip is a, each PC is responsible for rendering and encoding for a/M frames.

Furthermore, as a distribution form of the sending out processing, similarly, distribution according to the number of frames can be exemplified.

Here, in FIG. 17, for each distributable processing of FV_1 and FV_2, the processing time length is shown to be halved in a case where the distributed processing of the pattern B is selected. However, as understood from the above description, the time length of the distributable processing (in particular, rendering processing) can be changed depending on the factors such as the generation processing load of the FV clip, the processing capability of the PC, and the communication condition. However, in the description here, it is assumed that there is almost no difference in the time length of the FV clip, the generation processing load, the processing capability of the PC, and the communication condition.

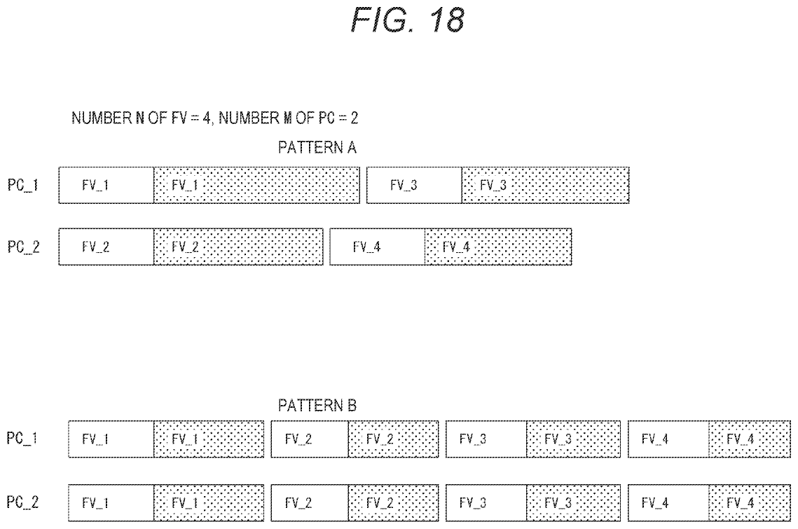

FIG. 18 is an explanatory diagram of the pattern A and the pattern B in a case where the number N of FVs is 4 and the number M of PCs is 2.

In this case, in the pattern A, PC_1 is responsible for the fixed processing (white pattern) and the distributable processing (dotted pattern) of two FVs among four FVs, and PC_2 is responsible for the fixed processing and the distributable processing of remaining two FVs. Specifically, FIG. 18 shows an example in which PC_1 is responsible for the fixed processing and the distributable processing of FV_1 and the fixed processing and the distributable processing of a FV_3, and PC_2 is responsible for the fixed processing and the distributable processing of FV_2 and the fixed processing and the distributable processing of a FV_4.

On the other hand, in the pattern B, the distributable processing of all the FVs to be generated, that is, FV_1, FV_2, FV_3, and FV_4 is subjected to distributed processing by PC_1 and PC_2.

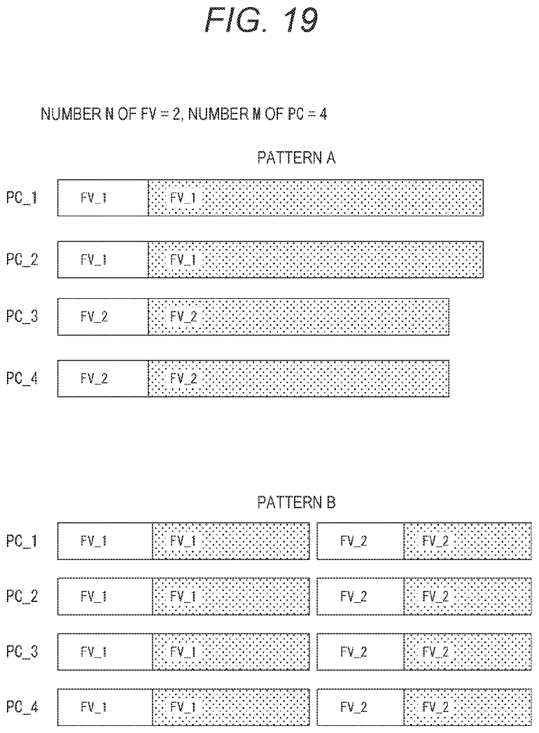

FIG. 19 is an explanatory diagram of the pattern A and the pattern B in a case where the number N of FVs is 2 and the number M of PCs is 4.

In this case, in the pattern A, although it is possible to adopt a method of allocating each FV to respective ones of the PCs such that only PC_1 is responsible for the fixed processing and the distributable processing of FV_1 and only PC_2 is responsible for the fixed processing and the distributable processing of F?V_2 as in the example of FIG. 17. However, in this case, because the number M of PCs>the number N of FVs, it is more efficient to execute the distributed processing on one FV by the plurality of PCs. Therefore, in the pattern A in this case, N/M PCs execute the distributed processing for the distributable processing on one FV, and the remaining N/M PCs execute the distributed processing for the distributable processing of the other FV. Specifically, FIG. 19 shows an example in which the distributable processing of FV_1 is subjected to the distributed processing by PC_1 and PC_2, and the distributable processing of FV_2 is subjected to the distributed processing by PC_3 and PC_4.

Note that the pattern A in this case uses the distributed processing in combination, but basically belongs to the processing pattern of the “pattern A” in which “the plurality of free viewpoint image PCs 2 executes the generation processing of different FV clips in parallel”.

In addition, in FIG. 19, in the pattern B, the distributable processing of all the FVs to be generated, that is, FV_1 to FV_4 is subjected to the distributed processing by each of the PCs which are PC_1 to PC_4.

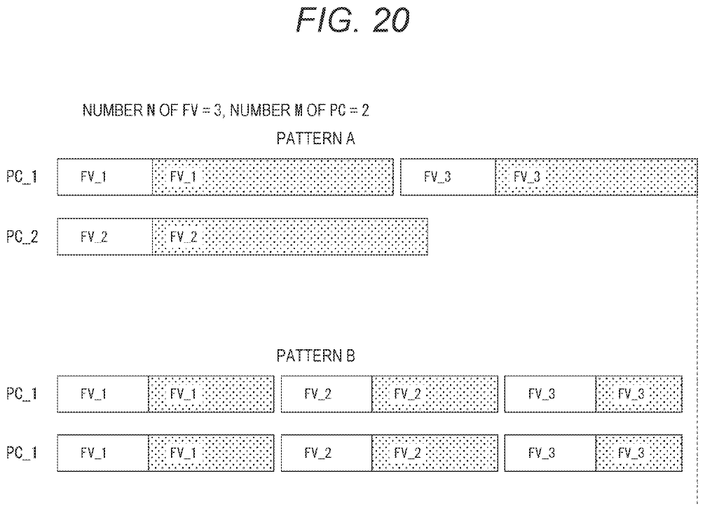

FIG. 20 is an explanatory diagram of the pattern A and the pattern B in a case where the number N of FVs is 3 and the number M of PCs is 2.

In this case, in the pattern A, one PC among two PCs is responsible for the fixed processing and the distributable processing of two FVs among three FVs, and the other PC is responsible for the fixed processing and the distributable processing of remaining one FV. Specifically, in the example in FIG. 20, an example is shown in which PC_1 is responsible for the fixed processing and the distributable processing of EV_1 and FV_3, and PC_2 is responsible for the fixed processing and the distributable processing of FV_2.

In addition, in the pattern B in this case, the distributable processing of each FV among FV_1 to EV_3 is subjected to the distributed processing by PC_1 and PC_2.

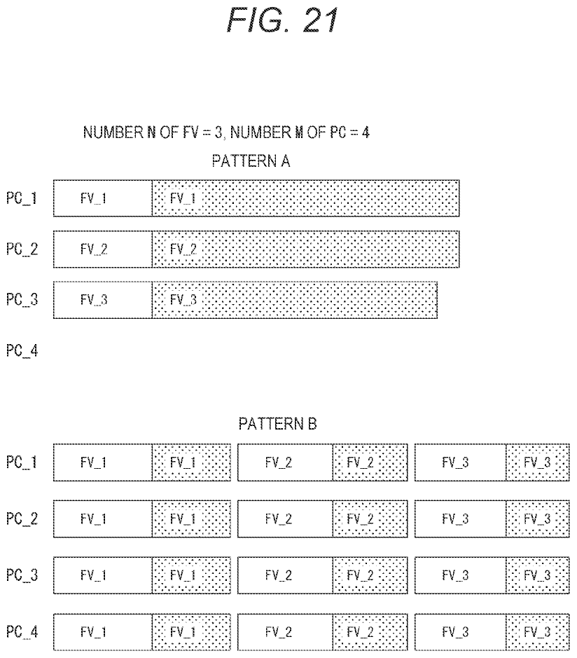

FIG. 21 is an explanatory diagram of the pattern A and the pattern B in a case where the number N of FVs is 3 and the number M of PCs is 4.

In the pattern A in this case, the same number of PCs as the number N of FVs execute the fixed processing and the distributable processing of different FVs in parallel. Specifically, FIG. 21 shows an example in which PC_1, PC_2, and PC_3 respectively execute the fixed processing and the distributable processing of the corresponding one of FV_1, FV_2, and FV_3 in parallel.

In addition, also in this case, in the pattern B, each PC executes distributed processing of each FV. Specifically, as illustrated, the distributable processing of each FV among EXT_1 to FV_3 is subjected to the distributed processing by PC_1, PC_2, PC_3, and PC_4.

Here, as can be seen from the comparison between FIGS. 18 and 20, in a case where the number N of FVs is larger than the number M of PCs (N>M), and in a case where the number N of FVs can be divided by the number M of PCs, selecting the pattern A shortens the time required for output clip creation as compared with selecting the pattern B.

Therefore, in the present embodiment, the determination unit 35 determines whether or not the number N of FVs can be divided by the number M of PCs in a case where the number N of FVs>the number M of PCs is satisfied, and determines that each PC is individually responsible for different FVs in a case where the number N of FVs can be divided by the number M of PCs (see the pattern A in FIG. 18). Specifically, in this case, because the number of FVs to be allocated to each PC is N/M, each PC is individually responsible for different N/M FV clips.

On the other hand, in a case where the number N of FVs>the number M of PCs is satisfied and the number N of FVs cannot be divided by the number M of PCs, the determination unit 35 determines that each of the PCs executes distributed processing on each of the FVs (see the pattern B in FIG. 20).

In addition, as can be seen from the comparison between FIGS. 17, 19, and 21, in a case where the number N of FVs>the number M of PCs is not satisfied, and regardless of whether or not the number M of PCs can be divided by the number N of FVs, selecting the pattern A shortens the time required for output clip creation as compared with selecting the pattern B.

Therefore, in a case where the number N of FVs>the number M of PCs is not satisfied, the determination unit 35 determines that the plurality of free viewpoint image PCs 2 executes the generation processing of different FV clips in parallel.

Specifically, in a case where the number N of FVs>the number M of PCs is not satisfied, and in a case where the number N of FVs=the number M of PCs is satisfied (FIG. 17), the determination unit 35 determines that each of the PCs executes generation processing of different FV clips in parallel.

In addition, in a case where the number N of FVs<the number M of PCs is satisfied, when N FV clips are allocated to N PCs, there is a possibility to generate a PC that is not used, resulting in inefficiency. Therefore, in some cases, the distributed processing is used in combination. Specifically, in a case where the number N of FVs<the number M of PCs is satisfied, for example, in a case where the number M of PCs can be divided by the number N of FVs as in the example in FIG. 19, the determination unit 35 causes the distributable processing of different FV clips to be subjected to distributed processing for every M/N PCs.

On the other hand, in a case where the number N of FVs<the number M of PCs is satisfied, for example, in a case where the number M of PCs cannot be divided by the number N of FVs as in the example in FIG. 21, the determination unit 35 allocates N EVs to N PCs.

### 9. Processing Procedure

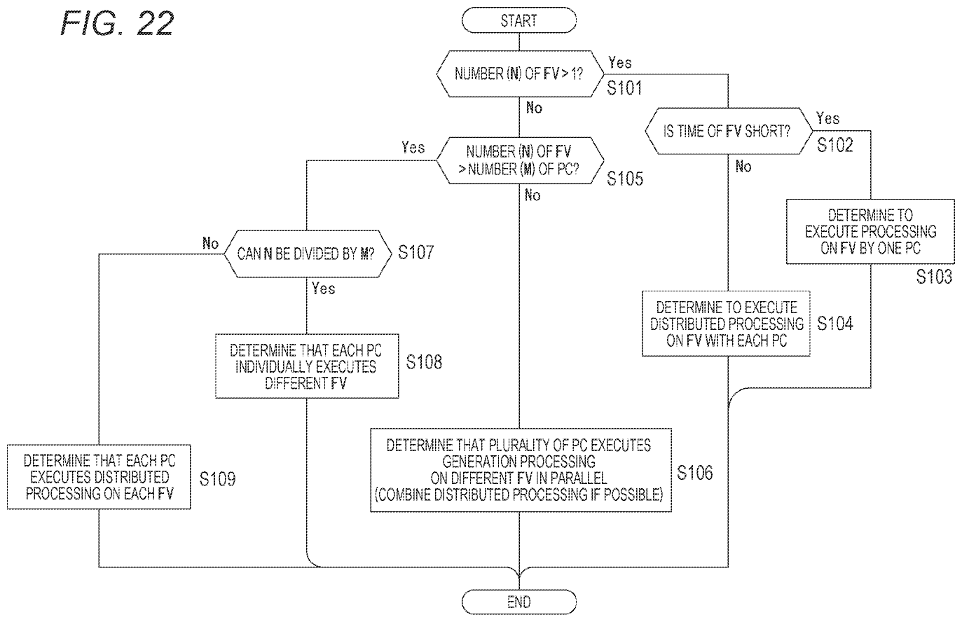

FIG. 22 is a flowchart showing an example of a specific processing procedure that should be executed to achieve a speeding up method described above as the embodiment. In the present example, the processing shown in FIG. 22 is executed by the CPU 71 of the free viewpoint image PC 2 as the master among the plurality of free viewpoint image PCs 2 on the basis of a program stored in a predetermined storage device such as the storage unit 79.

First, in step S101, the CPU 71 determines whether or not the number N of FVs is plural (N>1). If the number N of FVs is not plural, the CPU 71 proceeds to step S102 and determines whether or not the time length of the FV is short. This corresponds to a process of determining whether or not the distributed processing is executed by a plurality of PCs for one FV clip to be generated.

Here, in a case where one FV clip is subjected to the distributed processing by the plurality of PCs, it is necessary to perform communication of data (for example, information indicating a distribution ratio or the like) necessary for executing the distributed processing among the plurality of PCs. However, in a case where the time length of the FV clip to be generated is significantly short, there is a possibility that the time required for clip creation becomes longer when the distributed processing is executed due to the relationship between the time required for the communication and the time shortened by the distributed processing.

Therefore, in step S102, it is determined whether or not the time length of the FV clip is equal to or less than a predetermined threshold value. Here, as the threshold value, for example, a threshold value is used, which is empirically determined from a result and the like of an experiment obtained by measuring a clip creation time in a case where the distributed processing is executed and a clip creation time in a case where the processing is executed by a single PC.

In a case where it is determined in step S102 that the time length of the FV clip is equal to or less than the above threshold value and the time length of the FV is short, the CPU 71 proceeds to step S103 and determines to execute the processing on the FV by one PC. That is, it is determined to execute the generation processing of one target FV clip with one free viewpoint image PC 2.

The CPU 71 finishes a series of processing shown in FIG. 22 in response to execution of the processing at step S103.

In a case where it is determined in step S102 that the time length of the FV clip is not equal to or less than the above threshold value and the time length of the FV is not short, the CPU 71 proceeds to step S104 and determines to execute the distributed processing on the FV by each of the PCs. That is, the distributable processing of one target FV clip is determined to be executed in a distributed manner in each of the free viewpoint image PCs 2.

The CPU 71 finishes a series of processing shown in FIG. 22 in response to execution of the processing at step S104.

In addition, in a case where it is determined in step S101 that the number N of FVs is plural, the CPU 71 advances the processing to step S105.

In step S105, the CPU 71 determines whether or not the number N of FVs is larger than the number M of PCs (N>M).

If the number N of FVs is not larger than the number M of PCs (N S M), the CPU 71 proceeds to step S106 and determines that the plurality of PCs executes generation processing of different FVs in parallel. That is, when the number M of PCs is equal to or larger than the number N of FVs, the processing pattern as the pattern A is selected.

As described above, in a case where the number N of FVs>the number M of PCs is not satisfied, and in a case where the number N of FVs=the number M of PCs is satisfied (FIG. 17), it is determined that each of the free viewpoint image PCs 2 execute generation processing of different FV clips in parallel.

In addition, in a case where the number N of FVs<the number M of PCs is satisfied, the processing pattern is selected on the basis of whether or not the number M of PCs can be divided by the number N of FVs. Specifically, in a case where the number N of FVs<the number M of PCs is satisfied, for example, in a case where the number M of PCs can be divided by the number N of FVs as in the example in FIG. 19, the CPU 71 determines that the distributable processing of different FV clips is subjected to distributed processing for every M/N free viewpoint image PCs 2. Note that, for confirmation, even in a case where the distributed processing is executed in this manner, there is a set of free viewpoint image PCs 2 that executes different FV clip generation processing in parallel, such as PC_2 and PC_3 in FIG. 19, and thus, the set is in the category of the pattern A.

Furthermore, in a case where the number N of FVs<the number M of PCs is satisfied, in a case where the number M of PCs cannot be divided by the number N of FVs as in the example in FIG. 21, the CPU 71 determines that N FV clips are to be allocated to N free viewpoint image PCs 2. That is, each of the N free viewpoint image PCs 2 in this case executes the generation processing for one FV clip.

The CPU 71 finishes a series of processing shown in FIG. 22 in response to execution of the processing at step S106.

In addition, in a case where it is determined in step S105 that the number N of FVs is larger than the number M of PCs, the CPU 71 proceeds to step S107 and determines whether or not the number N of FVs can be divided by the number M of PCs.

In step S107, in a case where it is determined that the number N of FVs can be divided by the number M of PCs, the CPU 71 proceeds to step S108 and determines that each of the PCs is individually responsible for the FV different from the others. That is, as in the example in FIG. 18 above, in a case where the number N of FVs>the number M of PCs is satisfied and the number N of FVs can be divided by the number M of PCs, it is determined that each of the free viewpoint image PCs 2 is individually responsible for the FV clip different from the others (that is, does not execute the distributed processing). In this case, because the number of FV clips is a multiple of the number M of PCs, each free viewpoint image PC 2 is responsible for the plurality of FV clips.

The CPU 71 finishes a series of processing shown in FIG. 22 in response to execution of the processing at step S108.

Furthermore, in step S107, in a case where it is determined that the number N of FVs cannot be divided by the number M of PCs, the CPU 71 proceeds to step S109 and determines that each of the FVs is subjected to distributed processing by each of the PCs. That is, as in the example in FIG. 20 above, in a case where the number N of FVs>the number M of PCs is satisfied and the number N of EVs cannot be divided by the number M of PCs, it is determined that each of the free viewpoint image PCs 2 executes the distributable processing of each of the FV clips by the distributed processing.

The CPU 71 finishes a series of processing shown in FIG. 22 in response to execution of the processing at step S108.

Here, in the above description, it has been assumed that there is almost no difference in the time length and the generation processing load of the FV clip to be generated, and in the processing capability and the communication condition of the free viewpoint image PC 2. However, it is also possible to select the pattern A and the pattern B in consideration of the time length and the generation processing load of the FV clip, and of the processing capability and the communication condition of the free viewpoint image PC 2.

Specifically, for example, for the corresponding combination among the combinations of the number N of FVs and the number M of PCs exemplified in FIGS. 17 to 21, for every free viewpoint image PC 2, the time length required for the fixed processing and the distributable processing in a case where the processing is allocated according to the pattern A and the time length required for the fixed processing and the distributable processing in a case where the processing is allocated according to the pattern B are calculated on the basis of the time length and the generation processing load of the FV clip, and on the basis of the processing capability and the communication condition of the free viewpoint image PC 2. Then, the maximum value among the time lengths of each of the free viewpoint image PCs 2 calculated for the pattern A is compared with the maximum value among the time lengths of each of the free viewpoint image PCs 2 calculated for the pattern B, and the pattern having the smaller maximum value is determined as the processing pattern to be adopted.

At this time, the time length of the FV clip and the generation processing load are reflected in the calculation of the time length required for the distributable processing.

For the generation processing load of the FV clip, information correlated with the number of objects that is present in the target space of the free viewpoint image generation is used. Specifically, it is conceivable to use information on the number of difference pixels (difference pixels with respect to the background image) and the number of detected subjects. The generation processing load is estimated to be higher as the number of objects is larger. Then, the calculation is done such that the processing time length becomes longer as the generation processing load is higher.

Furthermore, the processing capability of the free viewpoint image PC 2 is reflected in the calculation of the time length required for the fixed processing and the calculation of the time length required for the distributable processing. Here, as the information of the processing capability of the free viewpoint image PC 2, for example, it is conceivable to use specification information (such as the operation frequency, the number of cores, and the like) of the CPU 71 of the free viewpoint image PC 2. Alternatively, it is also possible to use actual processing capability information in which not only the specification information but also the processing load status of the CPU 71 is taken into consideration. The calculation is done such that the processing time length becomes shorter as the processing capability is higher.

Furthermore, evaluation information regarding communication is used for the communication condition of the free viewpoint image PC 2. Examples of evaluation information related to communication include, for example, information on communication line speed, a packet loss rate, information on radio wave strength in wireless communication, and the like. Such an evaluation information regarding communication is used for calculation of the time length required for the distributable processing (particularly, the processing time length of “sending out” shown in FIG. 16). The calculation is done such that the processing time length becomes longer as the evaluation is lower.

Note that, in the determination as to whether or not to select the distributed processing (pattern B), it is not essential to use all of the information on the time length and the generation processing load of the FV clip, the processing capability information and the evaluation information regarding communication of the free viewpoint image PC 2, and at least one of these pieces of information is only required to be used.

In addition, in the above-described method, it is not essential to adopt the above time length comparison method for pattern determination, that is, the method of comparing the maximum value of the processing time length of each PC in the case of adopting the pattern A with the maximum value of the processing time length of each PC in the case of adopting the pattern B. As described below, for example, it is also conceivable to compare an average value of the processing time length of each PC in the case of adopting the pattern A (hereinafter referred to as “average value in the case of adopting the pattern A”) with an average value of the processing time length of each PC in the case of adopting the pattern B (hereinafter referred to as “average value in the case of adopting the pattern B”).

Specifically, in a case where the number N of FVs>the number M of PCs is satisfied (see FIGS. 18 and 20), the average value at the time of adopting the pattern A is obtained by the following Expression 1.

“(Total time length of distributable processing)×1/M+(Fixed processing time length)×N/M” [Expression 1]

Here, the total time length of the distributable processing means a time length required in a case where the distributable processing is executed on all the FV clips to be generated. In addition, the fixed processing time length means a processing time length required for one time of fixed processing.

Furthermore, in a case where the number N of FVs>the number M of PCs is not satisfied (see FIGS. 17, 19, and 21), the average value at the time of adopting the pattern A can be obtained by the following Expression 2.

“(Total time length of distributable processing)×1/M+(Fixed processing time length)×1” [Expression 2]

On the other hand, the average value at the time of adopting the pattern B can be obtained by the following Expression 3 regardless of the combination of the number N of FVs and the number M of PCs.

“(Total time length of distributable processing)×1/M+(Fixed processing time length)×N” [Expression 3]

In a case where the number N of FVs>the number M of PCs is satisfied, the average value at the time of adopting the pattern A obtained by Expression 1 is compared with the average value at the time of adopting the pattern B obtained by Expression 3, and the pattern having the smaller value is selected.

On the other hand, in a case where the number N of FVs>the number M of PCs is not satisfied, the average value at the time of adopting the pattern A obtained by Expression 2 is compared with the average value at the time of adopting the pattern B obtained by Expression 3, and the pattern having the smaller value is selected.

However, with this method, there is a concern that the average value at the time of adopting the pattern A cannot be appropriately calculated by Expression 1 or Expression 2 in a case where the number N of FVs and the number M of PCs are indivisible by each other as shown in FIGS. 20 and 21.

Therefore, it is also conceivable to make the determination based on Expression 1, Expression 2, and Expression 3 as described above only in a case where the number N of FVs and the number M of PCs are divisible by each other. Specifically, first, it is determined whether or not the number N of FVs>the number M of PCs is satisfied, and in a case where N>M is satisfied, it is determined whether or not N can be divided by M. In a case where N cannot be divided by M, the pattern B is selected. On the other hand, in a case where N can be divided by M, the method using Expression 1 and Expression 3 described above is used to determine which one of the patterns A and B is selected.

Furthermore, in a case where N>M is not satisfied, it is determined whether or not M can be divided by N. Then, in a case where M cannot be divided by N, the pattern B is selected, and on the other hand, in a case where M can be divided by N, the method using Expression 2 and Expression 3 described above is used to determine which of the patterns A and B is selected.

### 10. Modified Examples

Here, the embodiment is not limited to the specific example described above, and configurations as various modified examples can be adopted.

For example, in the above description, the decoding and modeling processing is assumed to be non-distributable fixed processing, but is possibly be treated as distributable processing in the future. Specifically, the configuration is made such that one free viewpoint image PC 2 executes the decoding and modeling processing of the FV clip targeted for the distributed processing, and the result (modeling result) is shared by the other free viewpoint image PCs 2.

In that case, processing similar to the processing described above may be executed by handling processing including the decoding and modeling as distributable processing.

Furthermore, in the above description, an example has been described in which the processing capability information of the free viewpoint image PC 2 and the evaluation information regarding the communication are used for the calculation of the processing time length. However, at the time of determining whether or not to select the distributed processing, these pieces of information are not limited to being used only for the calculation of the processing time length.

For example, even if there is a plurality of free viewpoint image PCs 2, in a case where one of the free viewpoint image PCs 2 has low processing capability, if the free viewpoint image PC 2 having the low processing capability is used for the distributed processing, the processing time length becomes longer. Therefore, in such a case, it is conceivable to execute the generation processing of the target FV clip only with the free viewpoint image PC 2 having high processing capability without selecting the distributed processing.

Furthermore, the similar applies to the evaluation information regarding communication, and even if there is a plurality of free viewpoint image PCs 2, in a case where there is a free viewpoint image PC 2 with a poor communication condition, because the processing time length becomes longer if the distributed processing is executed using that free viewpoint image PC 2, and thus, it is conceivable to execute the generation processing of the target FV clip only with the free viewpoint image PC 2 with a good communication condition.

### 11. Summary of Embodiment

As described above, the information processing apparatus (free viewpoint image PC 2) according to the embodiment includes the determination unit (determination unit 35) that determines whether or not to generate the free viewpoint image by distributed processing using a plurality of processors on the basis of related information of processing related to the free viewpoint image.

Examples of the processing related to the free viewpoint image include input of information necessary for generating the free viewpoint image, image generation processing, processing of outputting the generated image, and the like. For example, on the basis of related information of these processing, it is determined whether or not to generate the free viewpoint image by distributed processing using the plurality of processors.

By determining the distributed processing based on such related information, the distributed processing can be selected corresponding to a case where it is estimated that the processing time is shortened by the distributed processing, and the clip including the free viewpoint image can be quickly created.

Furthermore, in the information processing apparatus according to the embodiment, the related information includes information regarding the feature of the free viewpoint image.

Therefore, it is possible to determine whether or not to execute distributed processing on the basis of, for example, the features of the free viewpoint image, such as a time length of the free viewpoint image and a generation processing load.

Therefore, the determination on whether or not to execute the distributed processing can be made on the basis of the features of the free viewpoint image, and the accuracy of speeding up the creation of the clip including the free viewpoint image by improving the determination accuracy can be increased.

Moreover, in the information processing apparatus according to the embodiment, the related information includes information regarding the time length of the free viewpoint image.

If the distributed processing is selected in a case where the time length of the free viewpoint image to be generated is short, there is a case where the time required for clip creation becomes longer. According to the above configuration, it becomes possible to determine whether or not to execute distributed processing on the basis of the time length of the free viewpoint image to be generated.

Therefore, the determination on whether or not to execute the distributed processing can be appropriately made, and the accuracy of speeding up the clip creation by improving the determination accuracy can be increased.

Furthermore, in the information processing apparatus according to the embodiment, the related information includes information regarding the generation processing load of the free viewpoint image.

The generation processing load of the free viewpoint image depends on, for example, the number of objects that are present in a target space and the like, and the processing time required for image generation also increases when the generation processing load is high. According to the above configuration, it becomes possible to determine whether or not to execute distributed processing on the basis of such a generation processing load.

Therefore, the determination on whether or not to execute the distributed processing can be appropriately made, and the accuracy of speeding up the clip creation by improving the determination accuracy can be increased.

Furthermore, in the information processing apparatus according to the embodiment, the related information includes information regarding the number of the free viewpoint image.

Depending on the number of the free viewpoint images to be generated, there is possibly a case where the time is shortened by the distributed processing or a case where the time is not shortened by the distributed processing.

According to the above configuration, because it is possible to determine whether or not to execute the distributed processing on the basis of the number of the free viewpoint images to be generated, the determination on whether or not to execute the distributed processing can be appropriately made, and the accuracy of speeding up the clip creation by improving the determination accuracy can be increased.

Moreover, in the information processing apparatus according to the embodiment, the related information includes information regarding the number of the processors.

Depending on the number of the processors, there is possibly a case where the time is shortened by the distributed processing or a case where the time is not shortened by the distributed processing.

According to the above configuration, because it is possible to determine whether or not to execute the distributed processing on the basis of the number of the processors, the determination on whether or not to execute the distributed processing can be appropriately made, and the accuracy of speeding up the clip creation by improving the determination accuracy can be increased.

Furthermore, in the information processing apparatus according to the embodiment, the related information includes information regarding the processing capability of the processor.

For example, in a case where a processor having significantly low processing capability is included or the like, there is possibly a case where the time required for clip creation can be shortened without executing distributed processing depending on the processing capability of the processor.

According to the above configuration, because it is possible to determine whether or not to execute the distributed processing on the basis of the processing capability of the processor, the determination on whether or not to execute the distributed processing can be appropriately made, and the accuracy of speeding up the clip creation by improving the determination accuracy can be increased.

Furthermore, in the information processing apparatus according to the embodiment, the related information includes the evaluation information regarding the communication between the processor and the external device.

Examples of evaluation information related to communication include, for example, information on communication line speed, a packet loss rate, information on radio wave strength in wireless communication, and the like. For a processor which is evaluated low in communication, even if the generation processing itself is fast with high processing capability, it takes time to input information necessary for generating the free viewpoint image and output the generated image, and if the distributed processing using such a processor is selected, there is a possibility that the time required for clip creation becomes longer.

According to the above configuration, because it is possible to determine whether or not to execute the distributed processing on the basis of the evaluation information regarding the communication, the determination on whether or not to execute the distributed processing can be appropriately made, and the accuracy of speeding up the clip creation by improving the determination accuracy can be increased.

Moreover, in the information processing apparatus according to the embodiment, in a case where the number of the free viewpoint images to be generated is larger than the number of the processors, in a case where the number of the free viewpoint images to be generated cannot be divided by the number of the processors, the determination unit obtains the determination result indicating that generation by the distributed processing is to be executed (see step S109 in FIG. 22).

In a case where the number of the free viewpoint images is larger than the number of the processors and the number of the free viewpoint images cannot be divided by the number of the processors, the time required for clip creation can be shorten by generating the free viewpoint images by distributed processing using the plurality of processors rather than causing the plurality of processors to execute generation processing of different free viewpoint images in parallel.

Therefore, according to the above configuration, the clip creation can be speeded up.

Furthermore, in the information processing apparatus according to the embodiment, in a case where the number of the free viewpoint images to be generated is not larger than the number of the processors, the determination unit can take a configuration in which a determination result can be obtained, the result indicating that the plurality of processors executes generation processing of different free viewpoint images in parallel (see step S106).

In a case where the number of free viewpoint images is not larger than the number of the processors, the time required for clip creation can be shortened by causing the plurality of processors to execute generation processing of different free viewpoint images in parallel rather than generating the free viewpoint images by distributed processing using the plurality of processors.

Therefore, according to the above configuration, the clip creation can be speeded up.

Furthermore, in the information processing apparatus according to the embodiment, the determination unit switches the method of the determination on the basis of the magnitude relationship between the number of the free viewpoint images to be generated and the number of the processors (see steps S105 to S107 in FIG. 22).

With this arrangement, the method of determination can be switched in response to a case where the determination condition as to whether or not to select the distributed processing is different between a case where the number of the free viewpoint images is larger than the number of the processors and a case where the number of the free viewpoint images is not larger than the number of the processors.

Therefore, the accuracy of speeding up the clip creation by improving the determination accuracy can be increased.

The information processing method according to the embodiment is an information processing method that includes determining, by the information processing apparatus, whether or not to generate the free viewpoint image by distributed processing using the plurality of processors on the basis of related information of processing related to the free viewpoint image.

With such an information processing method, functions and effects similar to functions and effects of the information processing apparatus as the embodiment described above can be obtained.

Furthermore, the information processing system according to the embodiment includes: the storage device (NAS 5) that stores the plurality of captured images having different viewpoints; the plurality of processors (CPU 71) that can execute generation processing of the free viewpoint image based on the plurality of captured images stored in the storage device; and the information processing apparatus (free viewpoint image PC 2) including the determination unit (determination unit 35) that determines whether or not to generate the free viewpoint image by distributed processing using the plurality of processors on the basis of related information of processing related to the free viewpoint image.

With such an information processing system, functions and effects similar to functions and effects of the information processing apparatus as the embodiment described above can be obtained.

Here, as the embodiment, a program can be considered, for example, for causing a CPU, a digital signal processor (DSP), or the like, or a device including the CPU, the DSP, or the like, to execute the processing by the determination unit 35 described with reference to FIGS. 17 to 22 and the like.

That is, the program of the embodiment is a program that can be read by a computer device, and causes the computer device to realize a function of determining whether or not to generate the free viewpoint image by distributed processing by the plurality of processors on the basis of the related information of processing related to the free viewpoint image.

With such a program, the determination unit 35 described above can be realized in a device as the information processing apparatus 70.

These programs can be recorded in advance in an HDD as a storage medium built in a device such as a computer device, a ROM in a microcomputer having a CPU, or the like.

Alternatively, in addition, the program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site via a network such as a local area network (LAN) or the Internet.

Furthermore, such a program is suitable for providing the determination unit 35 of the embodiment in a wide range. For example, by downloading the program to a mobile terminal device such as a personal computer, a portable information processing apparatus, a mobile phone, a game device, a video device, a personal digital assistant (PDA), or the like, the personal computer or the like can be caused to function as a device that achieves the processing as the determination unit 35 of the present disclosure.

Note that the effects described in the present description are merely examples and are not limited, and other effects may be provided.

### 12. Present Technology

Note that the present technology can also take the following configurations.
(1)
An information processing apparatus includes
a determination unit that performs, on the basis of related information of processing related to a free viewpoint image, determination on whether or not to generate the free viewpoint image by distributed processing using a plurality of processors.
(2)
The information processing apparatus according to (1) described above,
in which the related information includes information regarding features of the free viewpoint image.
(3)
The information processing apparatus according to (2) described above,
in which the related information includes information regarding a time length of the free viewpoint image.
(4)
The information processing apparatus according to (2) or (3) described above,
in which the related information includes information regarding a generation processing load of the free viewpoint image.
(5)
The information processing apparatus according to any one of (1) to (4) described above,
in which the related information includes information regarding the number of the free viewpoint images to be generated.
(6)
The information processing apparatus according to any one of (1) to (5) described above,
in which the related information includes information regarding the number of the processors.
(7)
The information processing apparatus according to any one of (1) to (6) described above,
in which the related information includes information regarding processing capability of the processors.
(8)
The information processing apparatus according to any one of (1) to (7) described above,
in which the related information includes evaluation information regarding communication between the processors and an external device.
(9)
The information processing apparatus according to any one of (1) to (7) described above, in which
in a case where the number of the free viewpoint images to be generated is larger than the number of the processors, in a case where the number of the free viewpoint images to be generated cannot be divided by the number of the processors, the determination unit obtains a determination result indicating that generation by the distributed processing is to be executed.
(10)
The information processing apparatus according to any one of (1) to (9) described above, in which
in a case where the number of the free viewpoint images to be generated is not larger than the number of the processors, the determination unit obtains a determination result indicating that a plurality of the processors executes generation processing of different ones of the free viewpoint images in parallel.
(11)
The information processing apparatus according to any one of (1) to (10) described above, in which
the determination unit switches a method of the determination on the basis of the magnitude relationship between the number of the free viewpoint images to be generated and the number of the processors.
(12)
An information processing method including
an information processing apparatus executing, on the basis of related information of processing related to a free viewpoint image, whether or not to generate the free viewpoint image by distributed processing using a plurality of processors.
(13)
An information processing system includes:
a storage device that stores a plurality of captured images having different viewpoints;
a plurality of processors that can execute generation processing of a free viewpoint image based on the plurality of captured images stored in the storage device; and
an information processing apparatus including a determination unit that determines whether or not to generate the free viewpoint image by distributed processing using a plurality of the processors on the basis of related information of processing related to the free viewpoint image.

### REFERENCE SIGNS LIST

2 Free viewpoint image PC
10 Imaging device
31 Target image acquisition unit
32 Image generation processing unit
32a Display processing unit
33 Transmission control unit
34 Camerawork generation processing unit
34a Display processing unit
35 Determination unit
70 Information processing apparatus
71 CPU
72 ROM
73 RAM
74 Bus
75 Input/output interface
76 Input unit
77 Display unit
78 Audio output unit
79 Storage unit
80 Communication unit
81 Removable recording medium
82 Drive

1. An information processing apparatus comprising
a determination unit that performs, on a basis of related information of processing related to a free viewpoint image, determination on whether or not to generate the free viewpoint image by distributed processing using a plurality of processors.

2. The information processing apparatus according to claim 1,
wherein the related information includes information regarding features of the free viewpoint image.

3. The information processing apparatus according to claim 2,
wherein the related information includes information regarding a time length of the free viewpoint image.

4. The information processing apparatus according to claim 2,
wherein the related information includes information regarding a generation processing load of the free viewpoint image.

5. The information processing apparatus according to claim 1,
wherein the related information includes information regarding a number of the free viewpoint images to be generated.

6. The information processing apparatus according to claim 1,
wherein the related information includes information regarding a number of the processors.

7. The information processing apparatus according to claim 1,
wherein the related information includes information regarding processing capability of the processors.

8. The information processing apparatus according to claim 1,
wherein the related information includes evaluation information regarding communication between the processors and an external device.

9. The information processing apparatus according to claim 1, wherein,
in a case where a number of the free viewpoint images to be generated is larger than a number of the processors, in a case where the number of the free viewpoint images to be generated cannot be divided by the number of the processors, the determination unit obtains a determination result indicating that generation by the distributed processing is to be executed.

10. The information processing apparatus according to claim 1, wherein,
in a case where a number of the free viewpoint images to be generated is not larger than a number of the processors, the determination unit obtains a determination result indicating that a plurality of the processors executes generation processing of different ones of the free viewpoint images in parallel.

11. The information processing apparatus according to claim 1, wherein
the determination unit switches a method of the determination on a basis of a magnitude relationship between a number of the free viewpoint images to be generated and a number of the processors.

12. An information processing method comprising
an information processing apparatus executing, on a basis of related information of processing related to a free viewpoint image, whether or not to generate the free viewpoint image by distributed processing using a plurality of processors.

13. An information processing system comprising:
a storage device that stores a plurality of captured images having different viewpoints;
a plurality of processors that can execute generation processing of a free viewpoint image based on the plurality of captured images stored in the storage device; and
an information processing apparatus including a determination unit that determines whether or not to generate the free viewpoint image by distributed processing using a plurality of the processors on a basis of related information of processing related to the free viewpoint image.
